(19) United States
(12) Patent Application Publication
(10) Pub. No.: US 2013/0321380 A1
(43) Pub. Date: Dec. 5, 2013

(54) SYSTEM AND METHOD OF SENSING ACTUATION AND RELEASE VOLTAGES OF INTERFEROMETRIC MODULATORS

(71) Applicant: QUALCOMM MEMS TECHNOLOGIES, INC., San Diego, CA (US)

(72) Inventors: Nao S. Chuei, San Mateo, CA (US); Wilhelmus Van Lier, San Diego, CA (US); Pramod K. Varma, San Diego, CA (US); Koorosh Aflatooni, Cupertino, CA (US); William J. Cummings, Clinton, WA (US)

(73) Assignee: QUALCOMM MEMS Technologies, Inc., San Diego, CA (US)

(21) Appl. No.: 13/789,511

(22) Filed: Mar. 7, 2013

Related U.S. Application Data
(63) Continuation of application No. 13/757,591, filed on Feb. 1, 2013.
(60) Provisional application No. 61/653,977, filed on May 31, 2012.
(60) Provisional application No. 61/653,980, filed on May 31, 2012.

(51) Int. Cl. G09G 3/00; H02N 1/00

(52) U.S. Cl. CPC G09G 3/00; H02N 1/006
USPC 345/212; 318/116

(57) ABSTRACT

This disclosure provides methods and apparatus for calibrating display arrays. In one aspect, a method of calibrating a display array includes determining a particular drive response characteristic and updating a particular drive scheme voltage between updates of image data on the display array. The drive response characteristic may be determined by applying a ramped voltage to a line of the array and detecting a current pulse due to a capacitance change on the line. The drive response characteristic can be determined based on data representing a width of a current pulse in the waveform or a weighted or unweighted area of a current pulse in the waveform.

### CROSS-REFERENCE TO RELATED APPLICATIONS

This patent application is a continuation of U.S. patent application Ser. No. 13/757,591, entitled System and Method of Sensing Actuation and Release Voltages of Interferometric Modulators. This patent application also claims priority to U.S. Provisional Patent Application No. 61/653,977 filed May 31, 2012 entitled “System and Method of Updating Drive Scheme Voltages,” and claims priority to U.S. Provisional Patent Application No. 61/653,980 filed May 31, 2012 entitled “System and Method of Updating Drive Scheme Voltages.” The disclosures of both of these applications are considered part of this application and are incorporated by reference herein.

### TECHNICAL FIELD

This disclosure relates to methods and systems of driving electromechanical systems and devices such as interferometric modulators.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method of calibrating an array of electromechanical elements. The method may include driving the array of electromechanical elements using an initial set of drive scheme voltages. The method may continue by generating a ramped voltage by charging a capacitor with a digitally controlled current and applying the ramped voltage to a subset of the array. The method may further include determining a drive response characteristic based at least in part on a capacitance change produced by applying the ramped voltage to the subset of the array. The method may include determining a first updated drive scheme voltage for the array based at least in part on the drive response characteristic. The method may also include driving the array using an updated set of drive scheme voltages, wherein the updated set of drive scheme voltages includes the first updated drive scheme voltage. The ramped voltage may be initiated, switched, and/or terminated to generate a complete biphasic waveform. The ramped voltage may also be initiated, switched, and/or terminated to generate other waveforms, or to generate a waveform made up of voltage of only one polarity. The ramped voltage may be initiated at a value greater than or less than zero. The method may produce a capacitance change that produces one or more current pulses. The method may include comparing data representing at least in part the capacitance change with data representing at least in part the ramped voltage. The data representing at least in part the ramped voltage may be generated by a counter circuit.

In another aspect, an apparatus for calibrating drive scheme voltages may include an array of display elements, a ramped voltage generator, wherein the ramped voltage generator includes at least a capacitor and a digitally controlled current source, wherein a first node of the capacitor is connected to the digitally controlled current source, and a current sensor. The digitally controlled current source may include a digitally controlled analog voltage source connected to a current source. The current sensor may include a plurality of variable gain resistors. The apparatus may also include at least one of an amplifier circuit, a counter, and a start point generator circuit.

In another aspect, an apparatus for calibrating drive scheme voltages includes means for displaying image data, means for digitally controlling charge on a capacitor to produce a ramped voltage, means for applying the ramped voltage to at least a portion of the means for displaying image data, and means for sensing current pulses induced by the ramped voltage.

Another innovative aspect of the subject matter described in this disclosure can be implemented in a method of calibrating an array of electromechanical elements. The method may include applying a ramp voltage to a subset of the array and detecting an induced waveform including one or more current pulses, evaluating one or more characteristics of the induced waveform in a region of the waveform containing at least a portion of a current pulse wherein the evaluating is based at least in part on data representing at least one of a width of a current pulse in the region and a weighted or unweighted area of a current pulse in the region, and determining a drive response characteristic based at least in part on the evaluated characteristics. The method may also include determining an updated drive scheme voltage for the array based at least in part on the determined drive response characteristic; and driving the array of elements using the updated drive scheme voltage. The method step of evaluating one or more characteristics of the induced waveform may include at least one of determining a value representing a peak current of the current pulse, determining a first voltage substantially equal to the ramp voltage at which the current pulse reaches a first threshold lower than the peak current as the current is increasing, and determining a second voltage substantially equal to the ramp voltage at which the current pulse reaches a second threshold lower than the peak current as the current is decreasing. The method step of evaluating one or more characteristics of the induced waveform may include calculating a value representing an area under a region of the induced waveform over a ramp voltage range. The method may evaluate a region of the induced waveform over the ramp voltage range containing all of a current pulse, only a central portion of a current pulse, or some other portion of a current pulse. The method step of evaluating one or more characteristics of the induced waveform may include calculating one or more values representing ramp voltages corresponding to approximately maximum slope portions of the region of the induced waveform.

Another innovative aspect of the subject matter described in this disclosure can be implemented in an apparatus for calibrating drive scheme voltages. The apparatus can include an array of electromechanical elements, a ramped voltage generator, a current sensor, driver circuitry configured to drive the array of electromechanical elements using an initial set of drive scheme voltages, and processor circuitry configured to initiate application of a ramp voltage to a subset of the array to produce an induced waveform including one or more current pulses, evaluate one or more characteristics of the induced waveform in a region of the waveform containing at least a portion of a current pulse, wherein the evaluating is based at least in part on data representing at least one of a width of a current pulse in the region and a weighted or unweighted area of a current pulse in the region; and determine a drive response characteristic based at least in part on the evaluated characteristics. The processor circuitry may also be configured to evaluate one or more characteristics of the induced waveform in a region of the waveform by determining a value representing a peak current of the current pulse, determining a first voltage substantially equal to the ramp voltage at which the current pulse reaches a first threshold lower than the peak current as the current is increasing, and determining a second voltage substantially equal to the ramp voltage at which the current pulse reaches a second threshold lower than the peak current as the current is decreasing. The processor circuitry may also be configured to evaluate one or more characteristics of the induced waveform in a region of the waveform by calculating a value representing an area under a region of the induced waveform over a ramp voltage range. The region of the induced waveform over the ramp voltage range may contain all or a portion of a current pulse. The processor circuitry may also be configured to evaluate one or more characteristics of the induced waveform in a region of the waveform by calculating a value representing an area under a region of the induced waveform over a ramp voltage range containing at least a portion of the current pulse weighted by a corresponding ramp voltage value or function thereof. The processor circuitry may also be configured to evaluate one or more characteristics of the induced waveform in a region of the waveform by calculating one or more values representing ramp voltages corresponding to approximately maximum slope portions of the region of the induced waveform.

Another innovative aspect of the subject matter described in this disclosure can be implemented in computer readable medium having instructions that may cause a calibration circuit to apply a ramp voltage to a subset of the array and detecting an induced waveform including one or more current pulses, evaluate one or more characteristics of the induced waveform in a region of the waveform containing at least a portion of a current pulse wherein the evaluation is based at least in part on data representing at least one of a width of a current pulse in the region and a weighted or unweighted area of a current pulse in the region, and determine a drive response characteristic based at least in part on the evaluated characteristics. The evaluation of one or more characteristics of the induced waveform may include determining a value representing a peak current of the current pulse, determining a first voltage substantially equal to the ramp voltage at which the current pulse reaches a first threshold lower than the peak current as the current is increasing, and determining a second voltage substantially equal to the ramp voltage at which the current pulse reaches a second threshold lower than the peak current as the current is decreasing. The evaluation of one or more characteristics of the induced waveform may include calculating a value representing an area under a region of the induced waveform over a ramp voltage range containing at least a portion of the current pulse. The region of the induced waveform over the ramp voltage range contains all or a portion of a current pulse. The evaluation of one or more characteristics of the induced waveform may include calculating a value representing an area under a region of the induced waveform over a ramp voltage range containing at least a portion of the current pulse weighted by a corresponding ramp voltage value or function thereof.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B are schematic exploded partial perspective views of a portion of an electromechanical systems (EMS) package including an array of EMS elements and a backplate.

FIG. 7 is a block diagram illustrating examples of a common driver and a segment driver for driving an implementation of a 64 color per pixel display.

FIG. 8 is a block diagram illustrating examples of two common drivers and two segment drivers for driving two sections of a 64 color display simultaneously.

FIG. 9 shows an example of a diagram illustrating movable reflective mirror position versus applied voltage for several members of an array of interferometric modulators.

FIG. 10 is a schematic block diagram of a display array coupled to driver circuitry and state sensing circuitry.

FIG. 11 is a schematic diagram showing test charge flow in the array of FIG. 12.

FIG. 12 is a flowchart illustrating a method of calibrating drive scheme voltages during use of an array.

FIG. 13 is a schematic diagram of another implementation of a display array with state sensing and drive scheme voltage update capabilities.

FIG. 14 is flowchart illustrating another method of calibrating drive scheme voltages in a display array.

FIG. 15 is a schematic block diagram of a display array coupled to driver circuitry and state sensing circuitry that senses actuation and release of the display elements during the application of a voltage ramp input.

FIG. 16A is a timing diagram illustrating ramp voltages that may be used to calibrate IMOD display elements.

FIG. 16B is a timing diagram illustrating current pulses that may be detected during the application of ramp voltages illustrated in FIG. 16A.

FIG. 17 is a schematic diagram of a circuit illustrating one implementation of the ramped voltage generator and current sensor of FIG. 15.

FIG. 18A is a schematic diagram of a circuit illustrating another implementation of a ramp generator circuit.

FIG. 18B is a schematic diagram of a circuit illustrating another implementation of a current sensing circuit.

FIG. 19 is a flowchart of one example of a method that may be performed by the circuits of FIGS. 17, 18A, and 18B when incorporated into a display device.

FIG. 20 is a flowchart illustrating an implementation of a method of determining a drive response characteristic for an array or a subset of an array of IMODs.

FIGS. 21A-21F illustrate different methods of analyzing the current pulses detected during application of the ramp voltage to determine values for actuation and release of the display elements.

FIGS. 22A and 22B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The voltages required to actuate, release, or maintain the state of a modulator can change through the life of the display, e.g., with wear or with a change in temperature. Voltages required to actuate, release, or maintain the state of a modulator can be measured by examining the entire array or a subset of the array. In some implementations, examinations of a subset of the array may be used to determine drive scheme voltages based on the measurements as a representative subset of the array.

Determining appropriate drive scheme voltages can be accomplished by a variety of methods. One method of calibrating a display array includes determining a particular drive response characteristic and updating a particular drive scheme voltage between updates of image data on the display array. The drive response characteristic may be determined by applying a ramped voltage to a line of the array and detecting a current pulse due to a capacitance change on the line. In some implementations, a ramped voltage output may be applied to a subset of the array and a current may be sensed as an output of the subset of the array. The ramped voltage output may be generated by a digitally controlled current source. The ramp start voltage may be digitally controlled as well. The current sensor may include variable gain resistors in connection with or as part of the current sensing circuitry. A drive response characteristic or a drive scheme voltage can be determined by evaluating data representing the sensed current. The sensed current can be compared to the ramped voltage output to determine one or more voltages at which the modulators in the subset of the array are changing state, e.g., actuating or releasing.

Particular implementations of the subject matter described in this disclosure can be implemented to realize one or more of the following potential advantages. Implementations described herein allow for accurate current control in a ramped voltage output, thereby generating a ramped voltage output with predictable and repeatable characteristics. A predictable ramped voltage output may limit or eliminate the need to separately and/or simultaneously measure the ramped voltage output for comparison. Further, implementations described herein allow for the initiation of the ramped voltage at a desired beginning voltage, thereby potentially reducing the time required to calibrate the components of the array. These implementations may be useful where small changes are expected between calibrations, e.g., where the ramped voltage may be initiated at a desired beginning voltage close to the expected drive response characteristic. By initiating and/or terminating the ramped voltage near the expected drive response characteristic, the calibration may not be required to ramp the ramped voltage through the complete ramped voltage limits, thereby speeding the determination procedure. Further, implementations described herein allow for the use of a variable gain current sensor, thereby reducing the number of current sensors in the calibration circuit and increasing the precision and accuracy of the gain across the current sensor.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

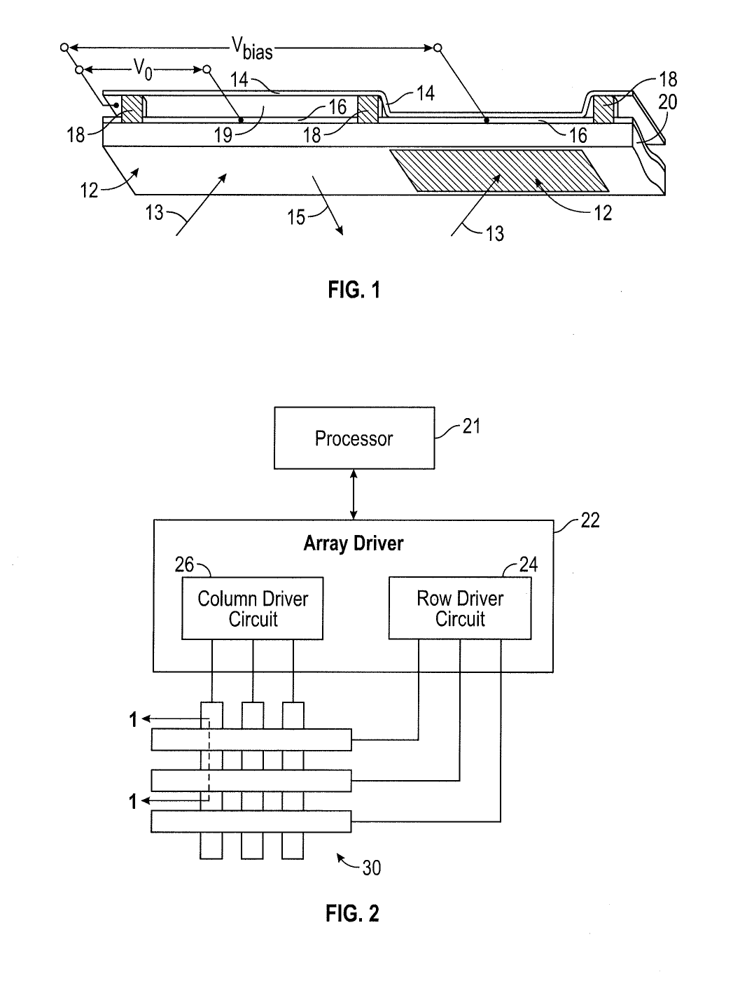

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

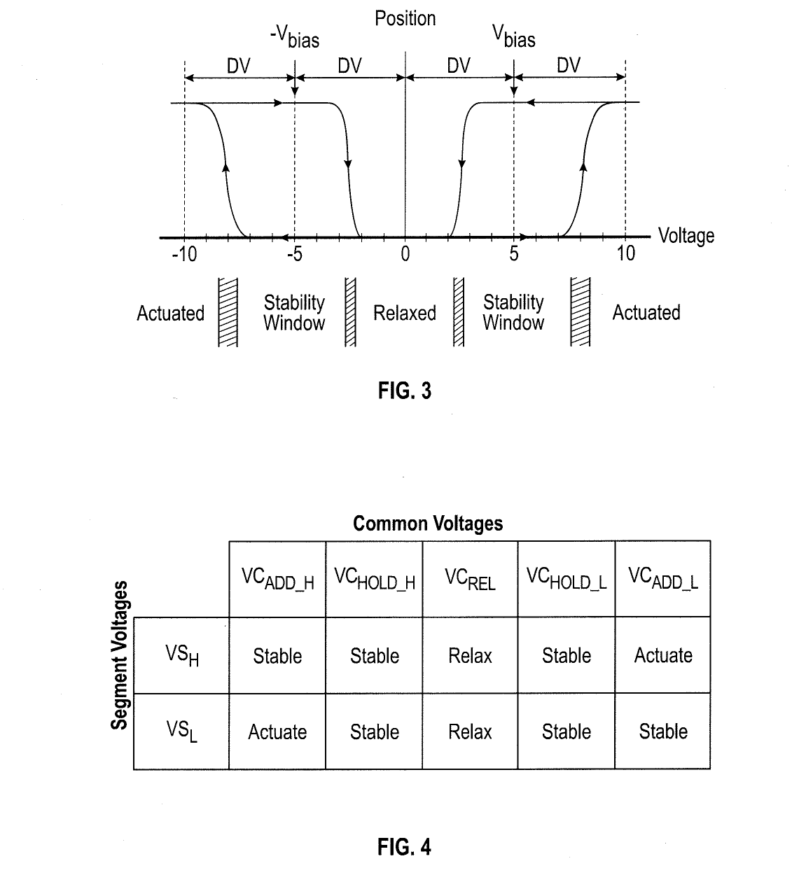

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

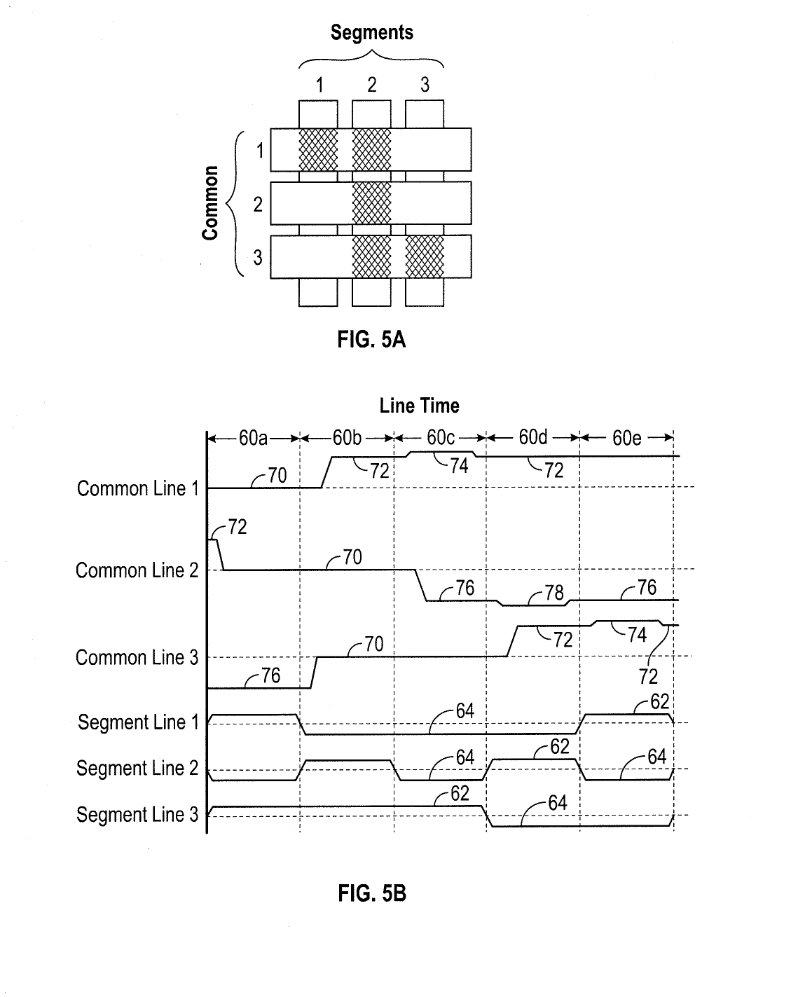

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

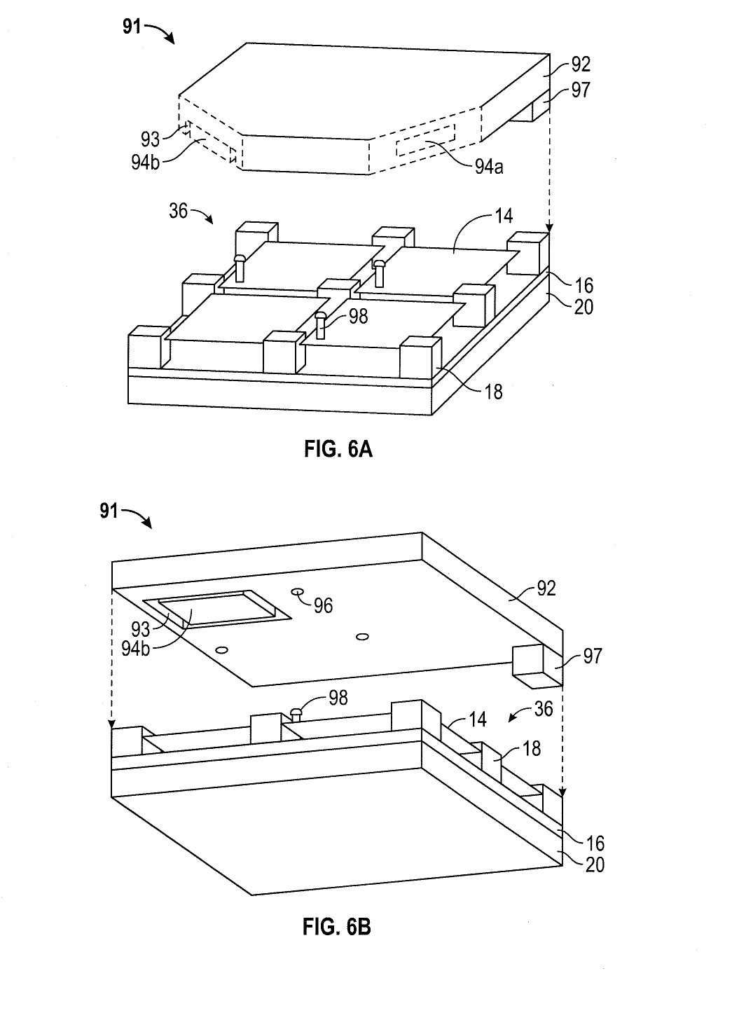

FIGS. 6A and 6B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 6A and 6B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

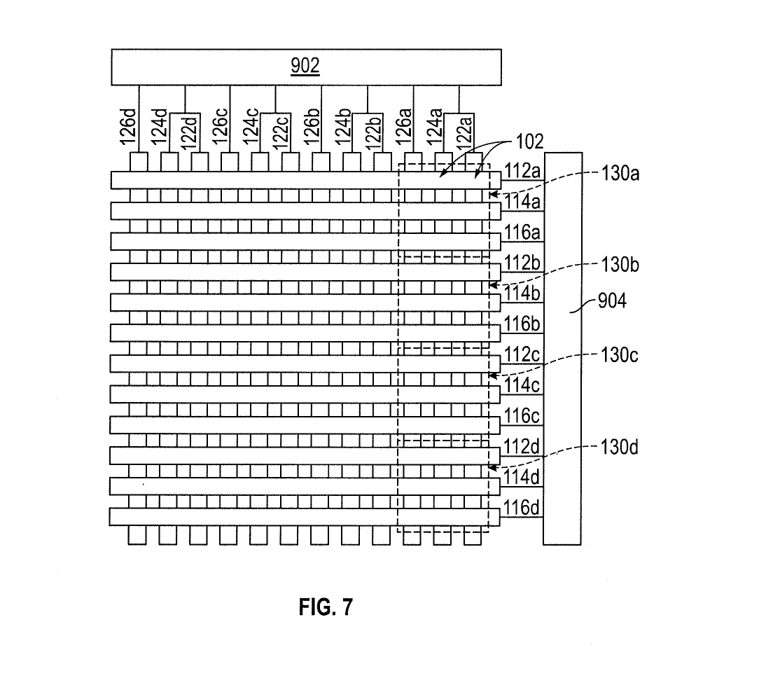

FIG. 7 is a block diagram illustrating examples of a common driver and a segment driver for driving an implementation of a 64 color per pixel display. The array can include a set of electromechanical display elements 102, which in some implementations may include interferometric modulators. A set of segment electrodes or segment lines 122a-122d, 124a-124d, 126a-126d and a set of common electrodes or common lines 112a-112d, 114a-114d, 116a-116d can be used to address the display elements 102, as each display element will be in electrical communication with a segment electrode and a common electrode. Segment driver 902 is configured to apply voltage waveforms across each of the segment electrodes, and common driver 904 is configured to apply voltage waveforms across each of the column electrodes. In some implementations, some of the electrodes may be in electrical communication with one another, such as segment electrodes 122a and 124a, such that the same voltage waveform can be simultaneously applied across each of the segment electrodes. Because it is coupled to two segment electrodes, the segment driver outputs connected to two segment electrodes may be referred to herein as a “most significant bit” (MSB) segment output since the state of this segment output controls the state of two adjacent display elements in each row. Segment driver outputs coupled to individual segment electrodes such as at 126a may be referred to herein as “least significant bit” (LSB) electrodes since they control the state of a single display element in each row.

Still with reference to FIG. 7, in an implementation in which the display includes a color display or a monochrome grayscale display, the individual electromechanical elements 102 may include subpixels of larger pixels. Each of the pixels may include some number of subpixels. In an implementation in which the array includes a color display having a set of interferometric modulators, the various colors may be aligned along common lines, such that substantially all of the display elements along a given common line include display elements configured to display the same color. Some implementations of color displays include alternating lines of red, green, and blue subpixels. For example, lines 112a-112d may correspond to lines of red interferometric modulators, lines 114a-114d may correspond to lines of green interferometric modulators, and lines 116a-116d may correspond to lines of blue interferometric modulators. In one implementation, each 3×3 array of interferometric modulators 102 forms a pixel such as pixels 130a-130d. In the illustrated implementation in which two of the segment electrodes are shorted to one another, such a 3×3 pixel will be capable of rendering 64 different colors (e.g., a 6-bit color depth), because each set of three common color subpixels in each pixel can be placed in four different states, corresponding to none, one, two, or three actuated interferometric modulators. When using this arrangement in a monochrome grayscale mode, the state of the three pixel sets for each color are made to be identical, in which case each pixel can take on four different gray level intensities. It will be appreciated that this is just one example, and that larger groups of interferometric modulators may be used to form pixels having a greater color range with different overall pixel count or resolution.

As described in detail above, to write a line of display data, the segment driver 902 may apply voltages to the segment electrodes or buses connected thereto. Thereafter, the common driver 904 may pulse a selected common line connected thereto to cause the display elements along the selected line to display the data, for example by actuating selected display elements along the line in accordance with the voltages applied to the respective segment outputs.

After display data is written to the selected line, the segment driver 902 may apply another set of voltages to the buses connected thereto, and the common driver 904 may pulse another line connected thereto to write display data to the other line. By repeating this process, display data may be sequentially written to any number of lines in the display array.

The time of writing display data (a.k.a. the write time) to the display array using such process is generally proportional to the number of lines of display data being written. In many applications, however, it may be advantageous to reduce the write time, for example to increase the frame rate of a display or reduce any perceivable flicker.

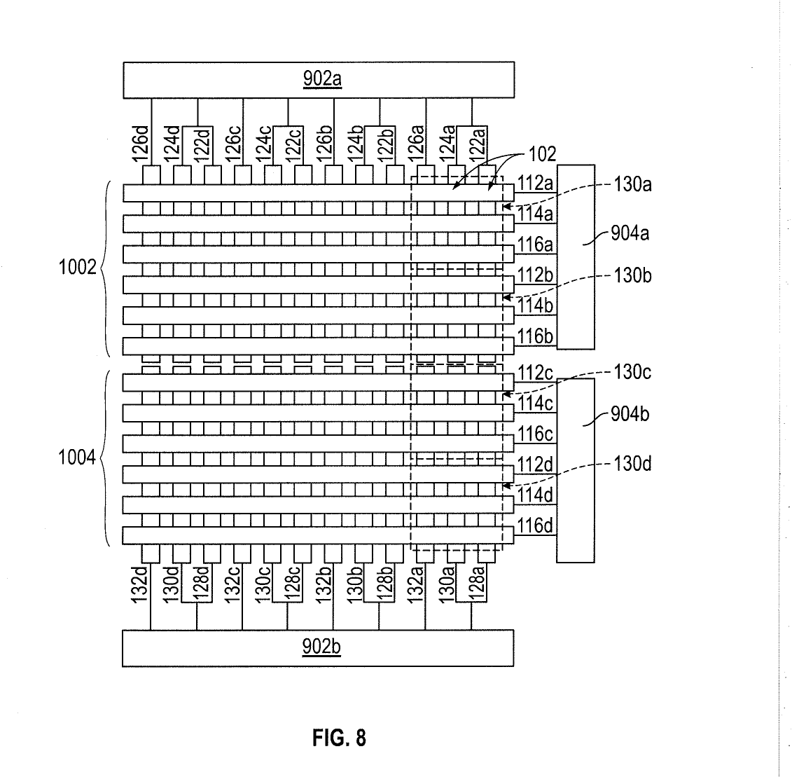

FIG. 8 is a block diagram illustrating examples of two common drivers and two segment drivers for driving two sections of a 64 color display simultaneously. In order to reduce the write time of a display array, the display array may be separated into two portions that can be driven in parallel. The display array illustrated in FIG. 8 includes sections 1002 and 1004. Further, two segment drivers 902a and 902b may be provided to drive each of the sections 1002 and 1004, respectively.

To write lines of display data in parallel to the display array of FIG. 8, the segment drivers 902a and 902b may each apply voltages to the respective buses connected thereto. For example, segment driver 902a may output data on each of segment outputs 122a-d, 124a-d, and 126a-d intended for the display elements along line 112a, and segment driver 902b may simultaneously output segment data on each of segment outputs 128a-d, 130a-d, and 132a-d intended for the display elements along line 112c. Thereafter, the common driver 904a may apply a write pulse to line 112a, and the common driver 904b may simultaneously apply a write pulse to line 112c, thus writing two lines simultaneously. This is repeated for each line of the array portions, typically cutting the write time of a frame substantially in half.

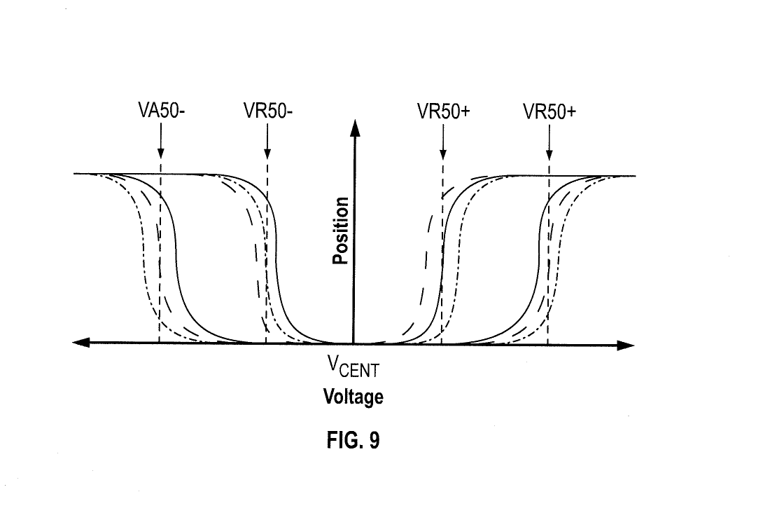

FIG. 9 shows an example of a diagram illustrating movable reflective mirror position versus applied voltage for several members of an array of interferometric modulators. FIG. 9 is similar to FIG. 3, but illustrates variations in hysteresis curves among different modulators in the array. Although each interferometric modulator generally exhibits hysteresis, the edges of the hysteresis window are not at identical voltages for all modulators of the array. Thus, the actuation voltages and release voltages may be different for different interferometric modulators in an array. In addition, the actuation voltages and release voltages can change with variations in temperature, aging, and use patterns of the display over its lifetime. This can make it difficult to determine voltages to be used in a drive scheme, such as the drive scheme described above with respect to FIG. 4. This can also make it useful for optimal display operation to vary the voltages used in a drive scheme in a manner that tracks these changes during use and over the life of the display array.

Returning now to FIG. 9, at a positive actuation voltage above a center voltage (denoted V_{CENT} in FIG. 9) and at a negative actuation voltage below the center voltage, each interferometric modulator changes from a released state to an actuated state. The center voltage is the midpoint between the positive hysteresis window and the negative hysteresis window. It can be defined in a variety of ways, e.g., halfway between the outer edges, halfway between the inner edges, or halfway between the midpoints of the two windows. For an array of modulators, the center voltage may be defined as the average center voltage for the different modulators of the array, or may be defined as midway between the extremes of the hysteresis windows for all the modulators. For example, with reference to FIG. 9, the center voltage may be defined as midway between the high actuation voltage and the low actuation voltage. As a practical matter, it is not particularly important how this value is determined, since the center voltage for an interferometric modulator is typically close to zero, and even when this is not the case, the various methods of calculating a midpoint between hysteresis windows will arrive at substantially the same value. In those implementations where the center voltage may is offset from zero, this deviation may be referred to as the voltage offset.

As described above, these values are different for different interferometric modulators. It is possible to characterize an approximate median positive and negative actuation voltage for the array, designated VA50+ and VA50− respectively in FIG. 9. The voltage VA50+ can be characterized as the positive polarity voltage that would cause about 50% of the modulators of an array to actuate. The voltage VA50− can be characterized as the negative polarity voltage that would cause about 50% of the modulators of an array to actuate. Using this terminology, the center voltage V_{CENT} may be defined as (VA50++VA50−)/2.

Similarly, at a positive polarity release voltage above the center voltage and at a negative polarity release voltage below the center voltage, the interferometric modulator changes from the actuated state to the released state. As with the positive and negative actuation voltages, it is possible to characterize an approximate middle or average positive and negative release voltage for the array, designated VR50+ and VR50− respectively in FIG. 9.

These average or representative values for the array can be used to derive drive scheme voltages for the array. In some implementations, a positive hold voltage (designated 72 in FIG. 5B) may be derived as the average of VA50+ and VR50+. A negative hold voltage (designated 76 in FIG. 5B) may be derived as the average of VA50− and VR50−. This puts the positive and negative hold voltages at approximately the center of a typical or average hysteresis window of the array. The positive and negative segment voltages (designated 62 and 64 in FIG. 5B, and referred to herein as VS+ and VS−) may be derived as the average of the two window widths, defined respectively as (VA50+-VR50+) and (VA50−-VR50−), divided by four. This sets the segment voltage magnitudes at approximately ¼ of the width of a typical or average hysteresis window of the array, with the actual segment voltages VS+ and VS− being the positive and negative polarities of this magnitude. In some implementations, the actuation voltage applied to the common lines (designated 74 in FIG. 5B) is derived as the hold voltage plus twice the segment voltage. In some implementations, an additional empirically determined value V_{adj} is added to the positive hold voltage and subtracted from the negative hold voltage computation described above. Although not always necessary, this can help avoid having portions of the display fail to actuate when desired during image data writing, which can be especially visible to the user in some cases. This additional parameter V_{adj} essentially moves the hold voltages slightly closer to the outer actuation edges of the hysteresis curves which helps ensure actuation of all display elements. If V_{adj} is too large, however, excessive false actuations may occur. In some implementations, values for VA50+ and VA50− may be in the 10-15 volt range. Values for VR50+ and VR50− may be in the 3-5 volt range. If, for example, measurements indicated a VA50+ of 12V, a VA50− of −12V, a VR50+ of 4V, and a VR50− or −4V, the above computations would set the positive and negative hold voltages at +8 and −8 volts respectively (if V_{adj} is zero), and the segment voltages would be +2V and −2V. An interferometric modulator being actuated during a write pulse would have a voltage of 8+3*2 V applied across it, which is 14 V, which may reliably actuate essentially any display element of the array if the median actuation voltage is 12V. A person having ordinary skill in the art would appreciate that the above voltages may vary in different implementations.

When the array is a color array having different common lines of different colors as described above with reference to FIG. 7, it can be useful to use different hold voltages for different color lines of display elements. Because different color interferometric modulators have different mechanical constructions, there may be a wide variation in hysteresis curve characteristics for interferometric modulators of different colors. Within the group of modulators of one color of the array, however, more consistent hysteresis properties may be present. For a color display, different values for VA50+, VA50−, VR50+, and VR50− can be measured for each color of display elements of the array. For a three color display, this is twelve different display response characteristics. In these implementations, positive and negative hold voltages for each color can be separately derived as described above using the four values of VA50+, VA50−, VR50+, and VR50− measured for that color. Because the segment voltages are applied along all the rows, a single segment voltage for all colors may be derived. This may be derived similar to the above, where an average hysteresis window width over both polarities and all colors is computed, and then divided by four. An alternative computation for a segment voltage may include computing a segment voltage for one or more colors separately as described above, and then selecting one of these (e.g., the smallest magnitude, the middle magnitude, the one from a particular color with visual significance, etc.) as the segment voltage for the entire array.

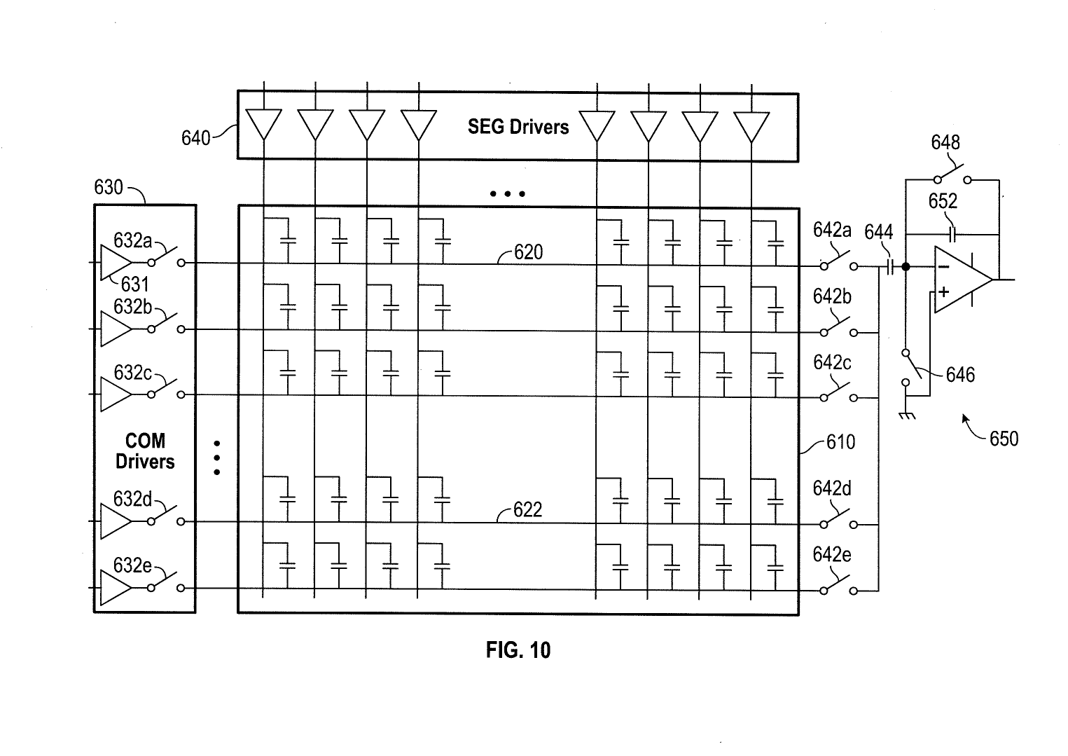

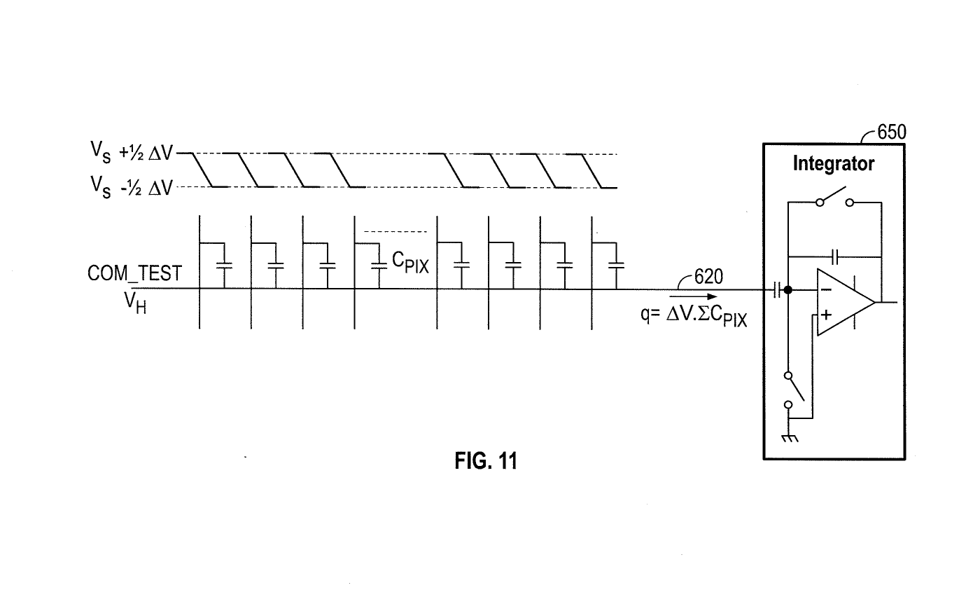

As mentioned above, the values for VA50+, VA50−, VR50+, and VR50− may vary between different arrays due to manufacturing tolerances, and may also vary in a single array with temperature, over time, depending on use, and the like. To initially set and later adjust these voltages to produce a display that functions well over its lifetime it is possible to incorporate testing and state sensing circuitry into a display apparatus. This is illustrated in FIGS. 10 and 11.

FIG. 10 is a schematic block diagram of a display array coupled to driver circuitry and state sensing circuitry. In this apparatus, a segment driver circuit 640 and a common diver circuit 630 are coupled to a display array 610. The display elements are illustrated as capacitors connected between respective common and segment lines. For interferometric modulators, the capacitance of the device may be about 3-10 times higher in the actuated state when the two electrodes are pulled together than it is in the released state, when the two electrodes are separated. This capacitance difference can be detected to determine the state or states of one or more display elements.

FIG. 11 is a schematic diagram showing test charge flow in the array of FIG. 10. In the implementation of FIG. 10, the detection is done with an integrator 650. The function of the integrator is described with further reference to FIG. 11. Referring now to FIG. 10 and FIG. 11, the common driver circuit 630 of FIG. 10 includes switches 632a-632e that connect test output drivers 631 to one side of one or more common lines. Another set of switches 642a-642e connect the other ends of one or more common lines to an integrator circuit 650.

As one example test protocol, each segment driver output could be set to a voltage, VS+, for example. Switches 648 and 646 of the integrator are initially closed. To test line 620, for example, switch 632a and switch 642a are closed, and a test voltage is applied to the common line 620, charging the capacitive display elements and an isolation capacitor 644. Then, switch 632a, 648, and 646 are opened, and the voltages output from the segment drivers are changed by an amount ΔV. The charge on the capacitors formed by the display elements is changed by an amount equal to about ΔV times the total capacitance of all the display elements. This charge flow from the display elements is converted to a voltage output by the integrator 650 with integration capacitor 652, such that the voltage output of the integrator is a measure of the total capacitance of the display elements along the common line 620.

This can be used to determine the parameters VA50+, VA50−, VR50+ and VR50− for a line of display elements being tested. To accomplish this, a first test voltage is applied that is known to release all of the display elements in the line. This may be 0 volts for example. In this instance, the total voltage across the display elements is VS+, which is, for example, 2V, which is within the release window of all the display elements. The output voltage of the capacitor when the segment voltages are modulated by ΔV is recorded. This integrator output may be referred to as Vₘᵢₙ for the line, which corresponds to the lowest line capacitance Cₘᵢₙ of the line. This is repeated with a common line test voltage that is known to actuate all of the display elements in the line, for example 20V. This integrator output may be referred to as Vₘₐₓ for the line, which corresponds to the highest line capacitance Cₘₐₓ of the line.

To determine VA50+ (positive polarity being defined here as common line at higher potential than segment line), the display elements of the line are first released with a low voltage, such as 0V on the common line. Then, a test voltage between 0V and 20V is applied. If the difference between the test voltage and the segment voltage is at VA50+, then the output of the integrator will be (Vₘₐₓ+Vₘᵢₙ)/2.

Since there may be no prior knowledge of the correct value for VA50+, it can be found efficiently with a binary search for the correct test voltage in some implementations. For instance, if VA50+ is exactly 12V, then the proper test voltage will be 14V, which will produce 12V across the display elements when the segment voltage is 2V as discussed in the example above. To run a binary search, the first test voltage can be the midpoint between the low and high voltages of 0V and 20V, which is 10V. When 10V test voltage is applied and the segment voltages are modulated, the integrator output will be less than (Vₘₐₓ+Vₘᵢₙ)/2, which indicates that 10V is too low. In a binary search, each next “guess” is halfway between the last value known to be too low and the last value known to be too high. Thus, the next voltage attempt will be midway between 10V and 20V, which is 15V. When 15V test voltage is applied and the segment voltages are modulated, the integrator output will be more than (Vₘₐₓ+Vₘᵢₙ)/2, which indicates that 15V is too high. Repeating the binary search algorithm, the next test voltage will be 12.5V. This will produce an integrator output that is too low, and the next test voltage will be 13.75V. This process can continue until the integrator output and test voltage are as close as desired to the actual values of (Vₘₐₓ+Vₘᵢₙ)/2 and 14V. In some implementations, eight iterations are almost always sufficient to determine VA50+ as the last applied test voltage minus the applied segment voltage. The search can be terminated prior to eight iterations if the integrator output is sufficiently close to (Vₘₐₓ+Vₘᵢₙ)/2, for example, within about 10%, or within about 1% of the desired (Vₘₐₓ+Vₘᵢₙ)/2 target value. To determine VA50− the process is repeated with negative test voltages applied to the common line. VR50+ and VR50− may be determined in an analogous manner, but the display elements are first actuated prior to each test, rather than released.

During manufacture of the array, this process can be performed on each line of the array to determine the parameters VA50+, VA50−, VR50+, and VR50− for each line. For a monochrome array, the values of VA50+, VA50−, VR50+, and VR50− for the array can be the average of the determined values for each line, and drive scheme voltages can be derived for the array as described above. For a color array, the values can be grouped by color, and drive scheme voltages for the array can also be derived as described above.

During use of such an array, it would be possible to repeat the above described process for each line and derive new drive scheme voltages that are suitable for the current condition of the array, temperature, etc. However, this can be undesirable because this procedure can take a significant amount of time and be visible to the user. To improve speed and to reduce interference with display viewing by the user, the array can be divided into subsets, and only one or more subsets of the array may be tested and characterized. These subsets can be sufficiently representative of the whole array such that the drive scheme voltages derived from these subset measurements are suitable for the whole array. This reduces the time required to perform the measurements, and can allow the process to be performed during use of the array with less inconvenience to the user. Referring back to FIG. 10, for example, a single line 622 of FIG. 10 can be selected as a representative subset of the array for testing and characterization during display use. Periodically during use of the array, switches 632d and 642d are used to test line 622 for VA50+, VA50−, VR50+, and VR50− and the results are used to derive updated drive scheme voltages. In some implementations, line 622 may have been previously determined as a representative line based on measurements of every line made during manufacture as described above. Generally, such a representative line will have one or more values for VA50+, VA50−, VR50+, and VR50− that are close to the average values of VA50+, VA50−, VR50+, and VR50− for all the lines of the array. In some implementations, several lines can be used as representative subsets of the array, and tested either simultaneously or sequentially by controlling switches 632a-632e and 642a-642e.

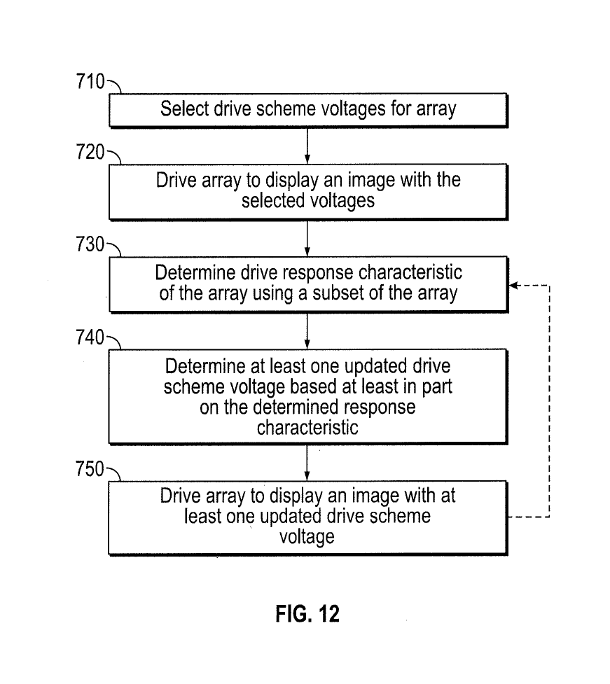

FIG. 12 is a flowchart illustrating a method of calibrating drive scheme voltages during use of an array. The method begins at block 710 where drive scheme voltages are selected for the array. These may be the voltages selected in the manufacturing process described above, or may be the current drive scheme voltages being used later in the life of the display. At block 720, the array is driven to display an image with the selected drive scheme voltages. At block 730, a drive response characteristic of the array is determined using a subset of the array. This may be one or more of the VA50+, VA50−, VR50+, and VR50− described above. At block 740, at least one updated drive scheme voltage is determined based at least in part on the determined drive response characteristic. At block 750, the array is driven to display an image with at least one updated drive scheme voltage. The method may then loop back to block 730, where a drive response characteristic is again measured.

In some implementations, during different loops of blocks 730 and 740, different subsets of the array can be used. Also, different drive response characteristics of the array can be measured. For example, during one loop, VA50+ can be determined for one line (or group of lines), and during a second loop, VR50− can be determined for a different line (or group of lines). With each loop, the drive scheme voltages can be updated with the new information. This can speed the measurement process within each loop between display image updates, reducing the visibility of the process to the user. This may further allow different subsets to be used for different drive response characteristics, as different subsets may be more representative of the entire array for certain drive response characteristics.

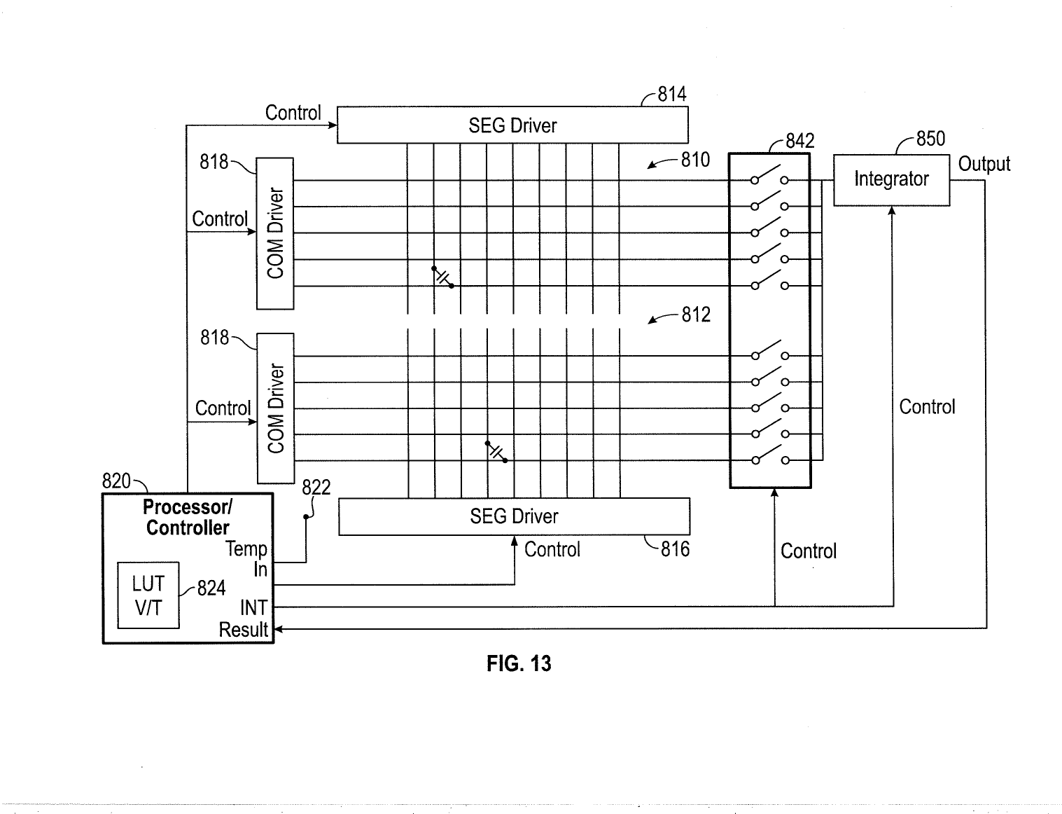

FIG. 13 is a schematic diagram of another implementation of a display array with state sensing and drive scheme voltage update capabilities. In this implementation, further features are included to make the update process faster, less visible, and more accurate. In FIG. 13, the display array is shown as two separate arrays, an upper array 810 and a lower array 812. The segment lines of the two arrays are driven with two segment drivers 814 and 816 respectively. The common lines are driven with a common driver circuit 818. A processor/controller 820 controls the driver circuits as well as a series of switches 842 and an integrator 850 which function as described above. The processor/controller 820 has access to a look up table 824 (which may be in a memory internal to or external to the integrated circuit of the processor/controller 820). Because changes in temperature are a significant factor in changes in drive response characteristics (and thus suitable drive scheme voltages), the look up table 824 stores information relating drive response characteristics or drive scheme voltages with temperature. This information may be initially obtained from testing of the display array during manufacture and/or known relationships between drive response characteristics and temperature. This implementation also includes a temperature sensor 822 located on or near the display array. The look up table 824 may contain values of VA50+, VA50−, VR50+ and VR50− for each color display element for a series of temperatures or temperature ranges. In some implementations, the processor/controller 820 takes the temperature value from the temperature sensor 822, retrieves the appropriate values for VA50+, VA50−, VR50+ and VR50− (e.g., 12 of them for a three color RGB display) from the look up table 824, calculates hold voltages for each color and a segment voltage from the above values, and controls the common driver circuit 818 and the segment drivers 814 and 816 to use the computed drive scheme voltages when writing image data to the display. As the temperature changes, the processor/controller 820 may select different drive scheme voltages according to the data in the look up table 824, even without additional testing of the display array during use.

Although this can help maintain the drive scheme voltages closer to their desired values, the data in the look up table 824 may contain some inaccurate values, and in addition, the actual values for VA50+, VA50−, VR50+ and VR50− for the display array as a function of temperature may change over time. To account for this, the system of FIG. 13 may be configured to periodically update the data in the look up table using measured values for VA50+, VA50−, VR50+ and VR50− obtained during use of the array.

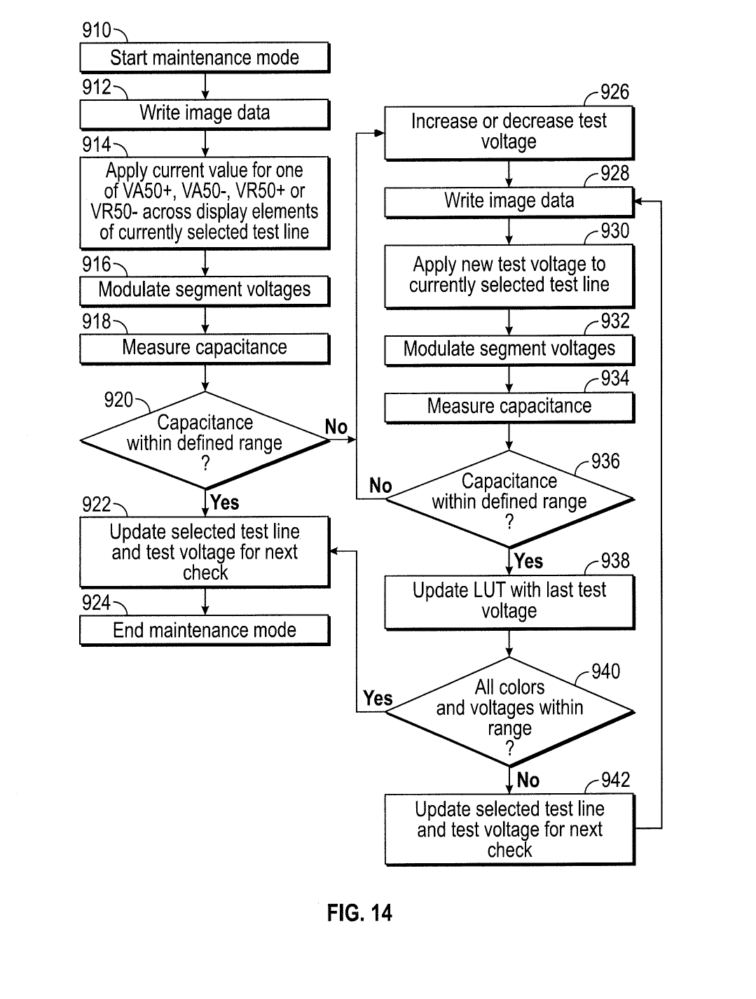

FIG. 14 is flowchart illustrating another method of calibrating drive scheme voltages in a display array. When using this method, a set of display element common lines are initially selected as representative of the display array. Any number of lines in any arrangement is possible, although generally one or more lines of each color will be selected. As one example, one red line, one blue line, and one green line in the upper array 810, and one red line, one blue line, and one green line in the lower array 812 may be selected. More than one (e.g., two, three etc.) of red lines, green lines, and blue lines in each display array may also be selected. In one implementation, four red lines, four green lines, and four blue lines are selected, where each selected line has a median value for one of the four parameters VA50+, VA50−, VR50+, and VR50− for that color. These selected lines may be designated initially during display manufacture as a set of lines that are characteristic of the whole display array. In addition, the Vₘᵢₙ and Vₘₐₓ corresponding to the Cₘᵢₙ and Cₘₐₓ for each of the lines may be initially determined, so that the integrator output at 50% actuated display elements (Vₘᵢₙ+Vₘₐₓ)/2 is known.

Referring now to FIG. 14, the method begins by entering a maintenance mode at block 910. This maintenance mode of FIG. 14 is a test and update routine that may be periodically performed over the life of the display. Because it may be essentially invisible to the user, the maintenance mode routine may be performed frequently, such as every few minutes or even every few seconds. In some implementations, the frequency with which the maintenance mode is run can depend on changes in temperature, wherein if the temperature is changing rapidly, the maintenance mode routine can be run more frequently.

At block 912, a frame of image data is written to the display array. At block 914 one of the set of representative lines is selected. Also, one of the response characteristics is selected for evaluation. For example, a representative red line may be selected, and VR50+ for red may be selected for measurement. The current value in the look up table for this parameter, in this case VR50+ for red at the current temperature is retrieved and a test voltage is selected that will place this voltage across the display elements of the selected line. This test voltage is applied (after actuating all the elements since a VR parameter is being measured) to the selected line. The segments are modulated as described above at block 916 and the integrator output is measured as a measure of the capacitance of the line at that applied voltage. If the selected parameter VR50+ for red from the look up table is accurate, the integrator output will be at or very close to the known (Vₘᵢₙ+Vₘₐₓ)/2 for that line. A suitable threshold may be defined to decide whether the integrator output is close enough to the known (Vₘᵢₙ+Vₘₐₓ)/2 to consider the current value accurate, for example, within about 10%, or within about 1% of the desired (Vₘₐₓ+Vₘᵢₙ)/2 target value. At decision block 920 it is determined whether the integrator output is within the desired range. If it is, the method may proceed to block 922 where the next line and response characteristic are selected for use in the next maintenance mode routine. From block 922, the method may exit the maintenance mode at block 924.

If it is determined at decision block 920 that the integrator output is too far above or below the known value for (Vₘᵢₙ+Vₘₐₓ)/2, then the test voltage to be applied next to the selected line may be increased or decreased depending on the integrator measurement by a certain amount, such as 50-100 mV at block 926. Then, at block 928 image data is again written to the display array. Blocks 914, 916, 918, and 920 are then essentially repeated at blocks 930, 932, 934, and 936 with the new test voltage, and the integrator output is again compared to the known (Vₘᵢₙ+Vₘₐₓ)/2. If the integrator output is still not within the desired range, the method loops back to block 926, where another test voltage adjustment is made and tested. After some repetitions of this loop, the correct test voltage that produces an integrator output close to (Vₘᵢₙ+Vₘₐₓ)/2 is obtained, and the method proceeds to block 938, where a new VR50+ is derived from the test voltage and the look up table is updated with the new value.

In this case, because the method has determined that the first value checked was in error, the method will proceed to check all of the response characteristics, and at decision block 940 will determine that at this stage not all parameters VA50+, VA50−, VR50+, and VR50− for all colors are within range. The method will then proceed to block 942 and select a new line and new response characteristic to check, e.g., the method may now select a green line, and test for the accuracy of the current look up table value for VA50+. The method then loops back to block 928, writes another frame of image data, and performs the illustrated test protocol for the new line and new response characteristic. This will be repeated until all response characteristics for all colors have been measured and updated where necessary. For a display with three colors and four response characteristics VA50+, VA50−, VR50+ and VR50− there will be twelve total iterations of selecting lines and response characteristics for test.

This method has several advantages. For each frame of image data written, only one test is performed, so it is very fast, typically less than 2 ms, and invisible to the user. When the user is using the display, and it is being updated at, for example, 15 frames per second, a test of one response characteristic for one line can be performed with each frame update without affecting the use or appearance of the display. In addition, because the look up table is initially populated with at least approximately accurate values and is being continually updated with new values, usually only small corrections need to be made with each run of the maintenance mode routine. This speeds up the process and eliminates the need to perform a binary search for a correct value with each test.

The process of FIG. 14 can be modified in a variety of ways. Several images can be written between each test for example. A method may also check all response characteristics for all colors with every run of the maintenance mode routine rather than exiting the routine if the first value checks as accurate. A method may also check half or any other portion of colors and response characteristics with some runs of the maintenance mode routine, and check other portions in other runs of the maintenance mode routine. As another modification, the look up table could store drive scheme voltages themselves as a function of temperature, and the system could recompute these values based on the test information for updating the look up table.

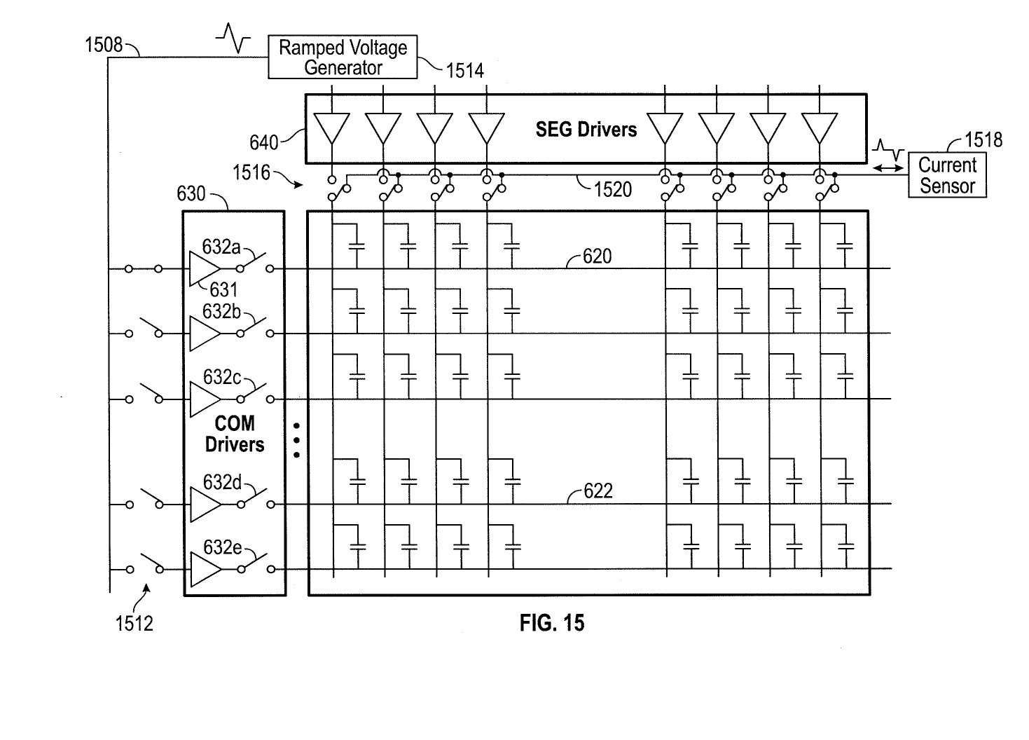

FIG. 15 is a schematic block diagram of a display array coupled to driver circuitry and state sensing circuitry that senses actuation and release of the display elements during the application of a voltage ramp input. FIG. 15 may be used as an alternative circuit to the state sensing circuit of FIG. 10. In this implementation, a set of common line switches 1512 is provided that can selectively connect an output line 1508 of a ramped voltage generator 1514 to individual ones of the common lines 620, 622. A second set of segment line switches 1516 is provided that can selectively connect to a sense line 1520 that provides an input to a current sensor 1518. When one or more of the common line switches is closed, as shown on switch 632a and the common line switch 1512 to the common line being tested 620, and one or more of the segment line switches are closed, as shown in the set of segment line switches 1516, a ramped voltage waveform may be applied to a common line. The set of segment line switches 1516 ties the segment lines to the sense line 1520, providing an input to the current sensor 1518.

In one example implementation, one common line 620 may be tested. Each switch 632a, common line switch 1512a, and the set of segment line switches 1516 are closed in this implementation. The ramped voltage generator generates a ramped voltage on the output line 1508. The current sensor 1518 may be configured such that the voltage on the sense line 1520 remains at or near zero at the time of the initial application of the ramped voltage to the common line being tested 620. In this implementation, if the output of the ramped voltage generator 1514 starts at zero, the interferometric modulators along the common line being tested 620 will all be in a released state. As the voltage ramps up in a positive direction, a voltage on the ramp will reach a point where the interferometric modulators on the line begin to actuate. As they actuate, the capacitance between the common line being tested 620 and the sense line 1520 increases. Each modulator causes a current spike on the sense line 1520 that coincides with the actuation event. The current spikes that result from actuation events by different modulators at substantially simultaneous times will be cumulative. Therefore, the more modulators that actuate at the same time, the larger the current spike will be. The ramped voltage may be generated until all of the modulators along the common line being tested 620 have been actuated by ramping the voltage past the actuation voltage for all of the modulators along the common line being tested 620. For example, generating a ramped voltage up to 20 V is suitable to actuate all the modulators being tested in many interferometric modulator implementations. After all of the modulators along the common line are actuated, the ramped voltage may then ramp downward back toward zero. As the ramped voltage approaches zero, the interferometric modulators along the line being tested will begin to release, causing a current spike of the opposite polarity. The ramped voltage may then go negative (to, for example, −20 V), and then back to zero, producing another pair of current pulses as the interferometric modulators actuate and release again, but under an applied voltage of the opposite polarity. In an implementation, the ramped voltage may be terminated after a single increase and decrease. In another implementation, the ramped voltage may first go negative and then go positive.

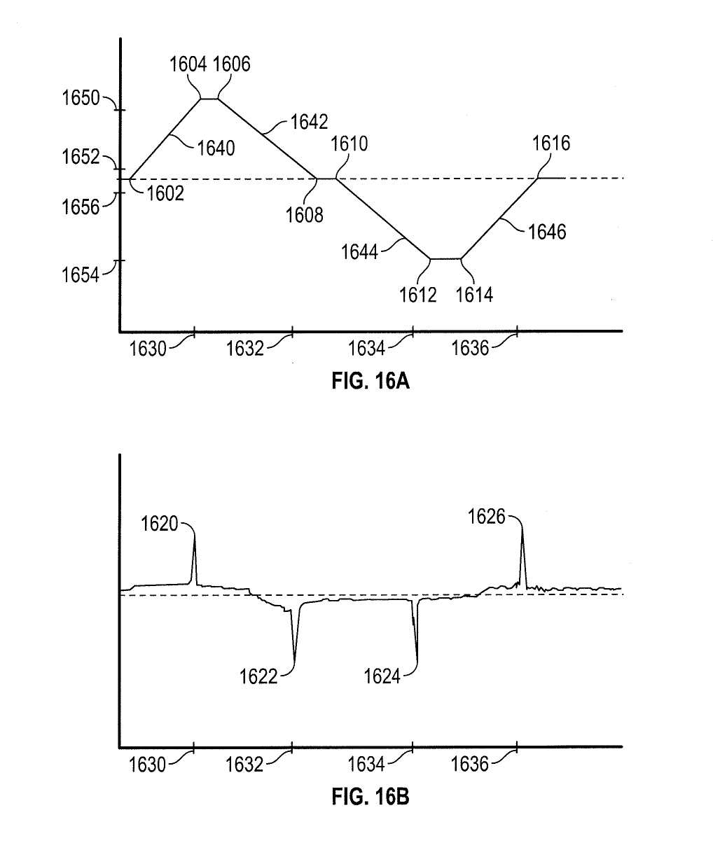

FIG. 16A is a timing diagram illustrating ramped voltages that may be used to calibrate IMOD display elements. FIG. 16B is a timing diagram illustrating current pulses that may be detected during the application of ramped voltages illustrated in FIG. 16A.

FIGS. 16A and 16B provide an example of the current generated on the sense line 1520 in response to a ramped voltage input on a common line to be tested 620. In this example implementation, the x-axes of the graphs in FIGS. 16A and 16B represent corresponding times, i.e., the time of the first current pulse 1620 shown as time 1630 corresponds to the same point in time as the time of the ramped voltage 1640 shown as time 1630. The y-axis of the graph in FIG. 16A represents voltage, as may be generated by the ramped voltage generator 1514 and applied to the common line to be tested 620. The y-axis of the graph in FIG. 16B represents current, as may be sensed by the current sensor 1518. The ramped voltage generator may generate linearly increasing and decreasing voltages between a highest positive ramped voltage 1604, 1606 and a lowest positive ramped voltage 1612, 1614.

In the example implementation, the voltage on the common line to be tested 620 is at approximately zero. If, for example, the switch 1512a in the set of common line switches 1512 is closed, the ramped voltage generator applies a linearly increasing or decreasing voltage across the common line to be tested 620. The current sensed by the current sensor remains low until the modulators along the common line to be tested 620 begin actuating. The modulators may be configured to actuate at approximately the same actuation voltage. As the modulators actuate, the current spikes generated at the time of actuation cumulatively result in a current pulse 1620, 1622, 1624, 1626 measured by the current sensor. In the example implementation, the voltage begins at approximately zero. An increasing ramped voltage is applied at the time represented by point 1602. At time 1630, the modulators actuate, resulting in a positive current pulse 1620. At time 1630, the ramped voltage is at an approximate value 1650. The ramped voltage increases linearly until the time represented by point 1604. The ramped voltage generator stops generating an increasing voltage at the time represented by point 1604. At the time represented by point 1606, a decreasing ramped voltage is applied. At time 1632, the modulators release, resulting in a negative current pulse 1622. At time 1632, the ramped voltage is at an approximate value 1652. The ramped voltage decreases linearly until the time represented by point 1608. At the time represented by point 1610, a decreasing ramped voltage is applied. At time 1634, the modulators actuate, resulting in a negative current pulse 1624. At time 1634, the ramped voltage is at an approximate value 1654. The ramped voltage decreases linearly until the time represented by point 1612. An increasing ramped voltage is applied at the time represented by point 1614. At time 1636, the modulators release, resulting in a positive current pulse 1626. At time 1636, the ramped voltage is at an approximate value 1656. The ramped voltage increases linearly until the time represented by point 1616.

In the example implementation, the ramped voltage 1650 at the maximum value of positive current pulse 1620 may correspond to the value for VA50+. The ramped voltage 1652 at the minimum value of negative current pulse 1622 may correspond to the value for VR50+. The ramped voltage 1654 at the minimum value of negative current pulse 1624 may correspond to the value for VA50−. The ramped voltage 1656 at the maximum value of negative current pulse 1626 may correspond to the value for VR50−. The ramped voltages and current sensing can be therefore used to determine drive response characteristics of the array as set forth above at block 730 of FIG. 12.

This scheme for determining the actuation and release voltages can have several advantages over the sequential application of different static voltages methods described above. First, the ramped voltage method may reduce the time required to determine actuation and release voltages for modulators in the display. The ramped voltage detection method can find each hysteresis curve edge in approximately 20% of the typical or average time required for the sequential application of static voltages. Second, the power drain of the ramped voltage method is also generally lower than the power drain for the sequential application method.

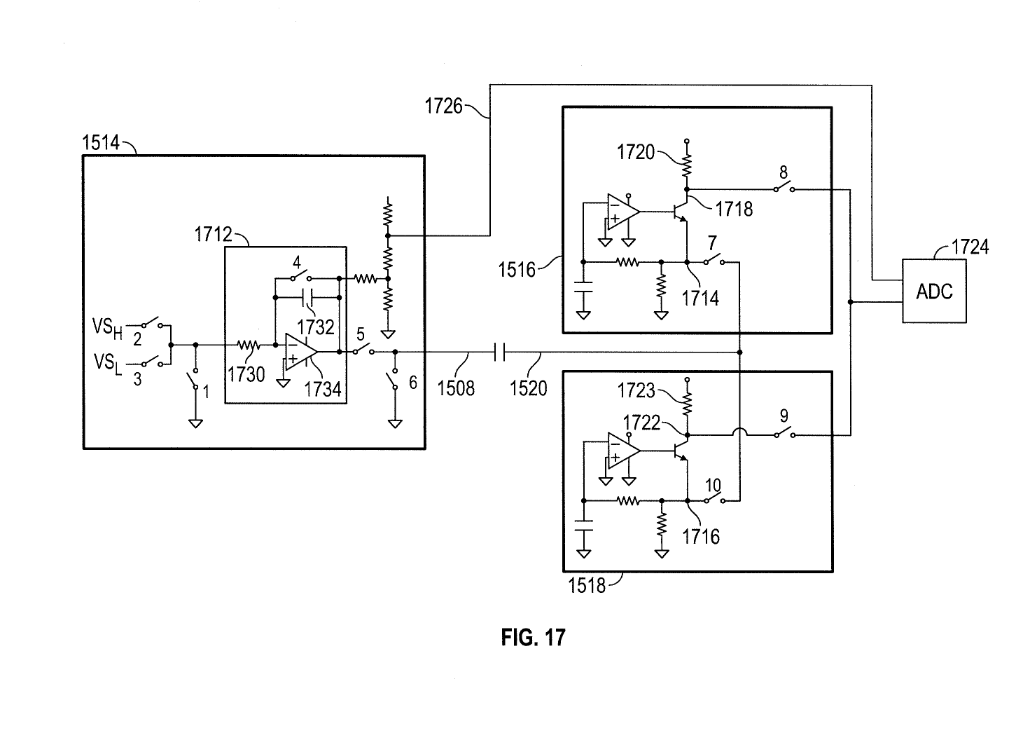

FIG. 17 is a schematic diagram of a circuit illustrating of one implementation of the ramped voltage generator and current sensor of FIG. 15. A variety of circuits may be used to generate the ramped voltage input and sense the current response. In the implementation shown in FIG. 17, ramped generator circuitry 1514 is configured to selectively provide an output to output line 1508. Output line 1508 is connected to one or more modulators in the display array represented by a capacitor between the output line 1508 and the sense line 1520. The sense line 1520 is configured to selectively connect to current sensors 1516, 1518. An analog to digital converter 1724 is configured to selectively receive output signals from the ramped generator circuitry 1514 and the current sensors 1516, 1518.

In this implementation, a ramped output is generated by an operational amplifier 1734 configured as an integrator 1712. The input to the integrator 1712 may alternatively be a positive voltage or negative voltage. The absolute values of the amplitude of the positive voltage and amplitude of the negative voltage may be approximately equal. The ramped voltage output of the integrator 1712 may be determined by the components of the integrator circuit. In this implementation, the slope of the output voltage will be determined by the input voltage V to the integrator circuit divided by the resistance R of resistor 1730 of the integrator 1712 and the capacitance C of the capacitor 1732 of the integrator 1712. The slope of the output voltage in this implementation would therefore be represented as V/RC. In this implementation, where in the input voltage V is either VSP when switch 2 is closed or VSN when switch 3 is closed, the slopes of the ramped voltage output in this implementation will be either VSP/RC or VSN/RC, depending on whether switch 2 or switch 3 is closed respectively. The current sensors 1516, 1518 are connected to sense line 1520 by switch 7 for current sensor 1516 and by switch 10 for current sensor 1518. The current sensors 1516, 1518 use an operational amplifier to hold the sense line 1520 at virtual ground at node 1714 when switch 7 is closed and at node 1716 when switch 10 is closed. When switch 7 is closed, the voltage at node 1718 is related to the current through resistor 1720, which is related to the current in the sense line 1520. If switch 10 is closed rather than switch 7, the same principles apply. In this case, the voltage at node 1722 is related to the current through resistor 1723, which is related to current in sense line 1520. Nodes 1718 and 1722 are selectively applied to the analog to digital converter 1724 for sampling, digitizing, and/or recording a sequence of time samples representing the current in the sense line 1520. A voltage at line 1726 that follows the output of the ramped voltage generator circuitry 1514 is also supplied to the analog to digital converter 1724. With this separately digitized output, the position of the current pulses detected in the sense line can be detected.

In the implementation shown in FIG. 17, the following example method may be used to apply a ramped voltage to the display array or a subset of the modulators in the display array and sense the current output. Switches 1, 4, 5, 6, 7, and 8 may initially be closed. Switches 2, 3, 9, and 10 may initially be open. When switches 1, 4, 5, 6, 7, and 8 are closed, any charge on the modulators on the display array or the subset of the display array being tested may be released and drained, stabilizing all the voltages on the display array or the subset of the display array being tested to zero. Switches 1 and 6 may then be opened and switch 3 may be closed. When switch 4 is then opened, the voltage output of the integrator 1712 will ramp up from zero. When switches 7 and 8 are closed, the upper sense circuit 1516 receives an input from the sense line 1520. The ramped voltage applied to line 1726 and the sense output at node 1718 are simultaneously recorded by the analog to digital converter 1724. After the ramped voltage output passes the actuation voltage of the modulators in the display array or the subset of the modulators in the display array being tested, switch 3 may be opened and switch 2 may be closed. In addition, switches 7 and 8 may be opened and switches 9 and 10 may be closed. The lower sense circuit 1518 of operates the same as the upper sense circuit 1516, except resistor 1723 may be larger than resistor 1720, resulting in a larger gain across the lower sense circuit 1518. The current pulses induced by release of the modulators may be smaller than the current pulses induced by actuation of the modulators. This difference in amplitude of the current pulses induced by release of the modulators and actuation of the modulators is due to the fact that the applied voltage when the release occurs is smaller than the applied voltage when the actuation occurs. Due to this difference in amplitude of the current pulse, it may be useful to use a larger gain in sensing the current induced by the release transition. When switch 3 is opened and switch 2 is closed, the slope of the ramped voltage output changes according to the slope described above. After the ramped voltage output passes the release voltage of the modulators in the display array or the subset of the modulators in the display array being tested and when the ramped voltage output reaches zero, switches 9 and 10 are opened again, and switches 7 and 8 closed. By opening switches 9 and 10 and closing switches 7 and 8, the upper sense circuit 1516 is again selectively connected to the sense line 1520 and the analog to digital converter 1724 and the lower sense circuit 1518 is selectively disconnected from the sense line 1520 and the analog to digital converter 1724. After the ramped voltage output passes the actuation voltage of the modulators in the display array or the subset of the modulators in the display array being tested (e.g., when the ramped voltage output reaches −20 V) switch 3 is opened and switch 2 is closed again, switching the ramped voltage output slope again, and switches 7 and 8 are opened and switches 9 and 10 are closed. After the ramp output passes the release voltage of the modulators in the display array or the subset of the modulators in the display array being tested and when the ramp reaches zero, the procedure is ended. The digital data recorded by the analog to digital converter 1724 may be analyzed to identify the positions of the current pulses that represent VA50+, VR50+, VA50−, and VR50−. In other implementations, the actuation or release voltage may be determined by one or more other methods.

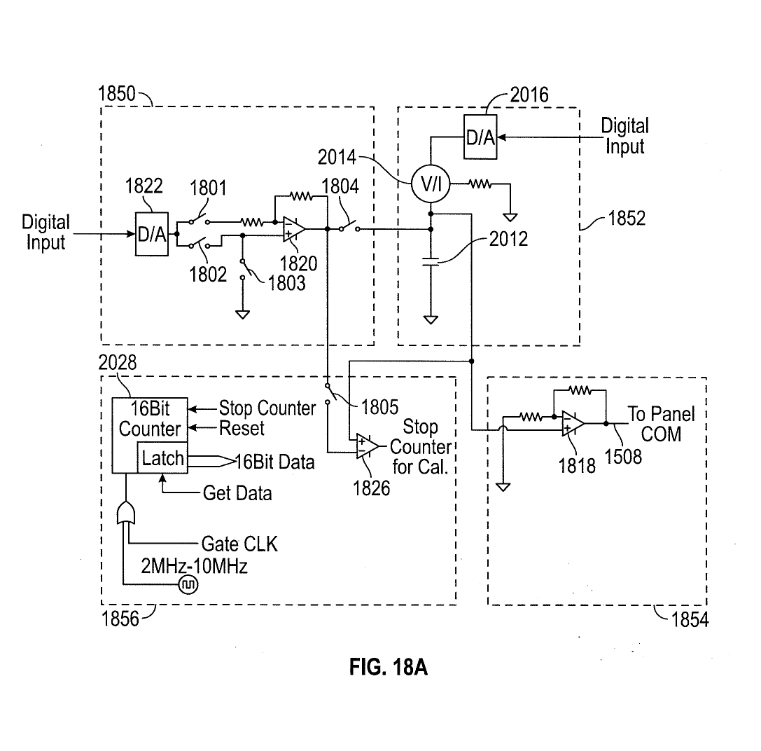

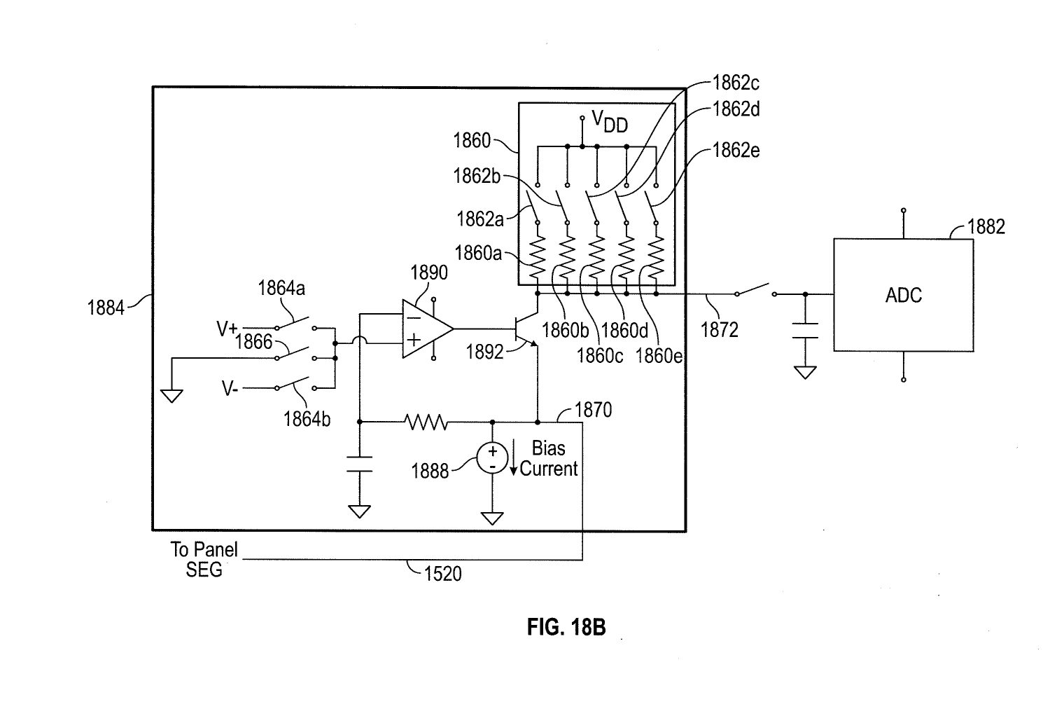

FIG. 18A is a schematic diagram of a circuit illustrating another implementation of a ramped voltage generator circuit. In the implementation shown in FIG. 18A, the circuit includes start point generator circuitry 1850, ramped voltage generator circuitry 1852, time calibration circuitry 1856, and amplification circuitry 1854.

The start point generator circuitry 1850 shown in the implementation in FIG. 18A includes a digitally controlled voltage source 1822. The digitally controlled voltage source 1822 can be connected to two switches 1801, 1802. Switch 1801 can be connected to a resistor which is further connected to a first input on operational amplifier 1820. Switch 1802 can be connected to a second input on operational amplifier 1820. The second input of operational amplifier 1820 can be further connected to switch 1803. Operational amplifier 1820 may be configured as an inverting amplifier and may be configured such that the output of operational amplifier 1820 may be depend on the open or closed state of switches 1801, 1802, and 1803. The start point generator circuitry may allow the initiation of the ramped voltage at a desired beginning voltage, thereby potentially reducing the time required to calibrate the components of the array. This implementations may be useful where small changes are expected between calibrations, e.g., where the ramped voltage may be initiated at a desired beginning voltage close to the expected drive response characteristic. By initiating and/or terminating the ramped voltage near the expected drive response characteristic, the calibration may not be required to ramp the ramped voltage through the complete ramped voltage limits, thereby speeding up the determination procedure.

The ramped voltage generator circuitry 1852 shown in the implementation in FIG. 18A includes a digitally controlled analog voltage source 2016. The output of the digitally controlled analog voltage source 2016 can be connected to a voltage to current converter 2014 to provide a digitally controlled current. During each ramp, the voltage to current converter 2014 functions as a constant current source having a magnitude controlled by the digital input. The output of the voltage to current converter 2014 can be connected to a first node of a capacitor 2012. The voltage to current converter 2014 can also be connected to a temperature compensation resistor.

The amplification circuitry 1854 shown in the implementation in FIG. 18A includes an operational amplifier 1818. The operational amplifier 1818 can be configured as a non-inverting amplifier. The output of the operational amplifier 1818 may be connected to apply an input voltage to circuitry including one or more common lines of an array of IMOD devices or an array or subset of an array of electromechanical devices.

The time calibration circuitry 1856 may include a counter 2028 and an operational amplifier 1826 configured as a comparator. One input to the operational amplifier 1826 may be connected to the output of start point generator circuitry 1850 via a switch 1805. The output of the operational amplifier 1826 may be provided as an input to the counter 2028.

In the implementation shown in FIG. 18A, a ramped voltage may be generated by charging the capacitor 2012 with the voltage to current converter 2014. The voltage to current converter 2014 may have output magnitude controlled by the digitally controlled analog voltage source 2016. In this implementation, the digitally controlled analog voltage source 2016 and the current source 2014 may provide a digitally controlled current. The first side of the capacitor 2012 connected to the current source 2014 is coupled to an input of operational amplifier 1818, which is configured as a non-inverting amplifier. In one implementation, the current source supplies current that produces a ramped voltage waveform that ranges in amplitude between +1 and −1 volt. The operational amplifier 1818 may be configured to have a gain of about 20, such that the signal produced on the output line 1508 is a ramped waveform that ranges between +20 volts and −20 volts.

In some implementations, the ramped voltage output may be initiated with the start point generator circuitry 1850. Prior to starting a ramp sequence, with the current output of the voltage to current converter 2014 set to zero, the output of the operational amplifier 1820 may be connected to the first side of the capacitor 2012 by closing the switch 1804. In some implementations, the gain of the amplifier circuit that includes operational amplifier 1820 may be one. If the gain is one, then when switches 1801 and 1802 are closed, and switch 1803 is open, the output of the operational amplifier 1820 is substantially equal to the voltage output from a digitally controlled voltage source 1822. When switches 1801 and 1803 are closed, and switch 1802 is open, the operational amplifier 1820 may thereby be configured as an inverting amplifier circuit. The output of the amplifier circuit 1820 may be the inverse of the voltage output from the digitally controlled voltage source 1822.

To initiate the ramp, switch 1805 can be open, switch 1804 can be closed, and switches 1801, 1802, 1803, and the digitally controlled voltage source 2022 are configured to produce a selected voltage level output onto capacitor 2012, which pre-charges the capacitor 2012 to the selected voltage level. The current source 2014 can then be initiated to supply a substantially constant current having a value suitable for producing the desired slope voltage ramp. As long as switch 1804 is in a closed state, the amplifier circuit including the operational amplifier 1820 can maintain the voltage on the capacitor 2012 constant at the selected voltage level. Any current delivered by current source 2014 may be sourced by or sunk to the amplifier circuit including the operational amplifier 1820. Switch 1804 may then be opened, causing the current I delivered by the current source 2014 to flow into the capacitor 2012, changing (by either raising or lowering depending on the direction of the current from current source 2014) the voltage on the capacitor 2012 as a linear ramp with slope I/C where C is the capacitance of the capacitor 2012. The current from voltage to current converter 2014 can be timed and controlled to flow in both directions to produce a complete biphasic ramp waveform, which is amplified by amplifier 1818 and delivered to output line 1508. In other implementations, the current from voltage to current converter 2014 may be timed and controlled to produce a ramp waveform in only one direction or slope and/or to produce a monophasic waveform that may include more than one direction or slope but only results from a positive voltage or negative voltage.

In the implementation shown in FIG. 18A, the circuit can generate timing information for calibrating the relationship between voltage changes on capacitor 2012 as a function of current from voltage to current converter 2014 and time from opening switch 1804. Whereas FIG. 17 uses an analog to digital converter to monitor the ramped voltage output of the ramped voltage generator, the circuit of FIG. 18A can instead generate timing information for calibration by determining the voltage on capacitor 2012 as a function of information provided by other components of the circuit. In one implementation, the circuit may generate timing information for calibrating the relationship between voltage changes on capacitor 2012 and the elapsed time from starting the ramp. Then, the timing of the current pulses may be correlated to the time since switch 1804 was opened, and the voltage at the output line 1508 at the time of the detected current pulses can be computed from the time and calibration information. For producing the calibration data, an operational amplifier 1826 configured as a comparator and a counter 2028 may be utilized. When the switch 1804 is opened, the counter 2028 begins counting. The output of the operational amplifier 1820 in the start point generator circuitry 1850 can be changed by digitally controlled voltage source 1822 to a desired test endpoint value. Switch 1805 may then be closed to send the output of the operational amplifier 1820 as a reference voltage to a first input of the operational amplifier 1826 configured as a comparator. The second input of the operational amplifier 1826 configured as a comparator may be connected to the capacitor 2012, such that the second input into the operational amplifier 1826 is the voltage across capacitor 2012. When the voltage across capacitor 2012 reaches the reference voltage, the output of the operational amplifier 1826 configured as a comparator transitions. The counter 2028 may be configured to stop at the time of the transition of the operational amplifier 1826 configured as a comparator. The time period for the ramped voltage output to change from the value at the beginning when switch 1804 was opened to the reference voltage value may be determined using the count and clock rate. The data provided to and by the counter 2028 can be used to derive the ramped voltage output on line 1508 or a drive response characteristic based on several variables, including the time at which switch 1804 is opened, the times at which the current from voltage to current converter 2014 is reversed, and the digital input to the digitally controlled analog voltage source 2016. In some implementations, the drive response characteristic is determined by an analog to digital converter component or by other processing circuitry.

FIG. 18B is a schematic diagram of a circuit illustrating another implementation of a current sensing circuit, which may be utilized in conjunction with the ramp generator of FIG. 18A. The current sensing circuit of FIG. 18B may share some operational principles with the current sensors 1516, 1518 of FIG. 17. The current sensing circuit of FIG. 18B can provide variable gain resistors for alternative use in an amplifier circuit, instead of providing two current sensors 1516, 1518 as shown in FIG. 17.

In the implementation shown in FIG. 18B, the sense line 1520 is configured to provide an input signal to the current sensing circuitry 1884. An analog to digital converter 1882 is configured to selectively receive output signals from the current sensing circuitry 1884 at output node 1872.

A ramped voltage output may be generated and applied to one or more modulators in an array or a subset of an array. The output signal from the modulators can be applied to sense line 1520. The current sensing circuitry 1884 uses an operational amplifier 1890 to hold the sense line 1520 at virtual return potential, where the virtual return potential may depend on the open or closed state of switches 1864 a, 1864b, and 1866. If switch 1866 is closed, sense line 1520 may be held at virtual ground at node 1870. If switch 1864a or 1864b is closed, sense line 1520 may be held at a virtual voltage V+ or V− respectively at node 1870, where the virtual voltage depends on the voltage applied at the switch 1864a. This allows for DC shifting the ramp voltage level across the modulators by an amount of V+ or V−.

The variable resistor circuit 1860 can allow selection of a variable gain across the current sensing circuitry 1884. In the implementation shown in FIG. 18B, the variable resistor circuit 1860 includes multiple resistors 1860a, 1860b, 1860c, 1860d, 1860e and multiple switches 1862a, 1862b, 1862c, 1862d, 1862e. Each resistor 1860a, 1860b, 1860c, 1860d, 1860e may be connected in series with one switch 1862a, 1862b, 1862c, 1862d, 1862e. Each resistor and switch connected in series may be further connected in parallel with the remaining resistors and switches. The variable resistor circuit may be configured to provide a selected gain by opening and closing one or more switches 1862a, 1862b, 1862c, 1862d, 1862e in order to selectively connect one or more resistors 1860a, 1860b, 1860c, 1860d, 1860e to the current sensing circuitry 1884.

The voltage at node 1872 is related to the current through the variable resistor circuit 1860, which is related to the current in the sense line 1520. In the implementation of FIG. 18B, a current source 1888 is set to bias the voltage of output node 1872 to V_{dd}/2 when there is no current entering or leaving sense line 1520. For example, if switch 1866 is closed and switch 1862a is closed, the bias current will be set to V_{dd}/2R, where R is the resistance of resistor 1860a. In this configuration, the voltage at node 1870 will be essentially zero, and the voltage at output node 1872 will be V_{dd}/2. If current then enters or exits node 1870 from sense line 1520, the amplifier 1890 will regulate the feedback transistor 1892 to cause the same magnitude but opposite polarity current change through resistor 1860a, causing a corresponding change in voltage at output node 1872 of the same polarity as the current on sense line 1520. The same initial bias of the output node 1872 can be used with a variety of expected signal amplitudes, where the gain may be changed by selecting a different gain resistor and corresponding bias current, where larger resistors and smaller bias currents correspond to more current in to voltage out gain. Node 1872 may be selectively applied to an analog to digital converter 1882 for sampling, digitizing, and/or recording a sequence of time samples representing the current in the sense line 1520.

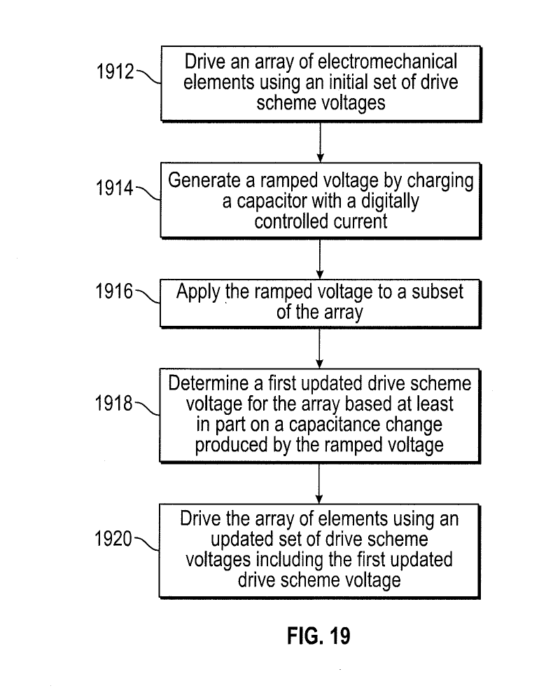

FIG. 19 is a flowchart of one example of a method that may be performed by the circuits of FIGS. 17, 18A, and 18B when incorporated into a display device. The method begins at block 1912, where an array of electromechanical elements is driven using an initial set of drive scheme voltages. At block 1914, a ramped voltage is generated by charging a capacitor with a digitally controlled current, and is applied to the array at block 1916. The subset may be a row of the array as described above. At block 1918, a first updated drive scheme voltage for the array is determined based at least in part on a capacitance change in the subset of the array produced by the ramped voltage. At block 1920, the array of elements is driven using an updated set of drive scheme voltages that include the first updated drive scheme voltage.

As described above, the ramp voltage value at which a current pulse occurs can be correlated to actuation and release voltages of the display elements that the ramp is applied to. In some cases, the position of the current pulse is defined by the ramp voltage corresponding to the peak amplitude of the current pulse. It has been found, however, that sometimes the current pulse exhibits a structure with more than one peak, or may be unsymmetrical around the peak. This has been found to cause some variation in test results even under identical test conditions. Implementations described below allow for increased repeatability and robustness in determining drive scheme voltages for the display array. Generally, methods using data representing current pulse widths or current pulse areas may produce more consistently repeatable results over test runs of the same line under the same conditions.

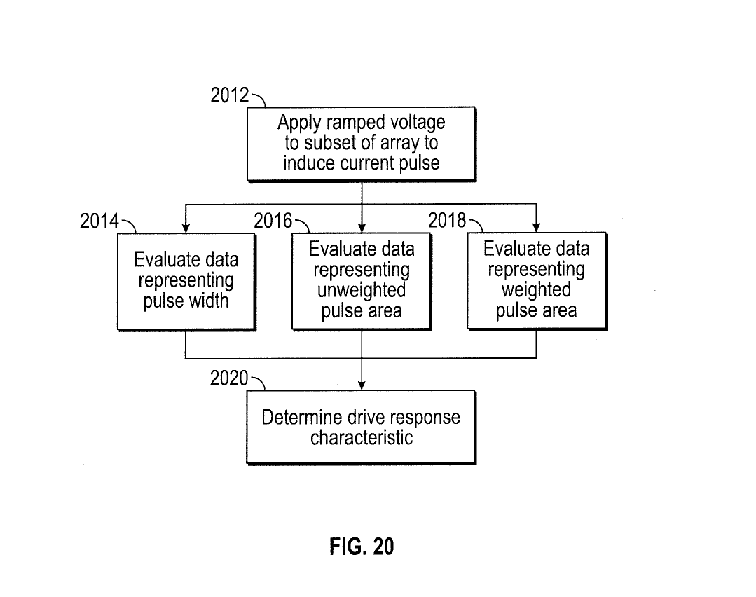

FIG. 20 is a flowchart illustrating an implementation of a method of determining a drive response characteristic for an array or a subset of an array of IMODs. The method begins at block 2012. At block 2012, the method applies a ramped voltage to a subset of an array of IMODs. The ramped voltage may induce a current pulse that can result from a change in state of the modulators in the subset of the array. The induced current pulse may be detected by current sensing circuitry, resulting in data that may be a waveform. The waveform may include one or more current pulses or a portion of a current pulse.

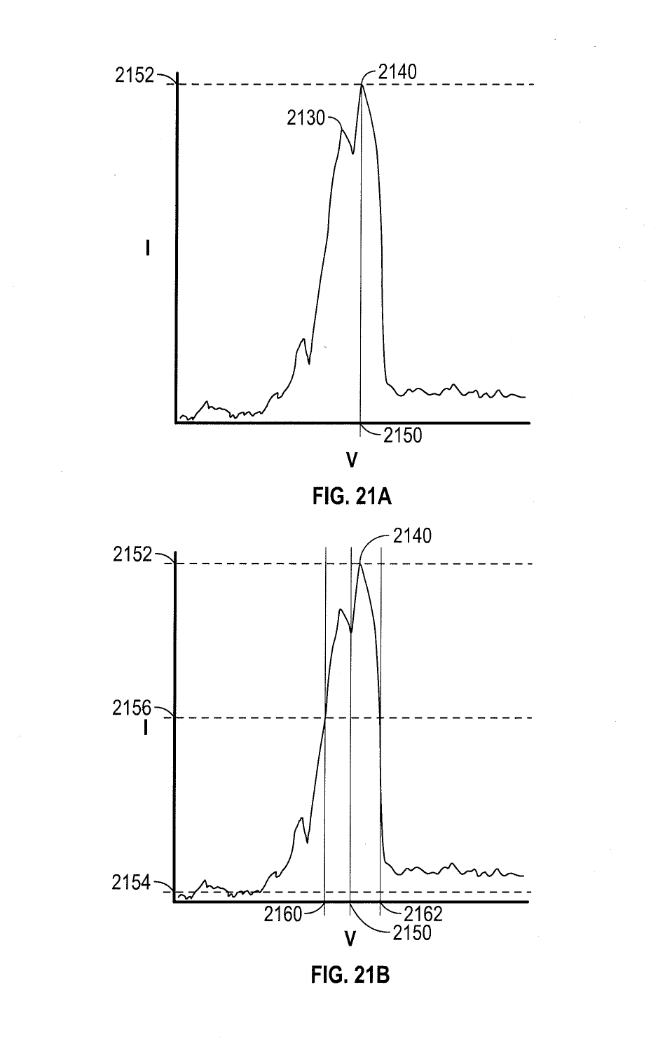

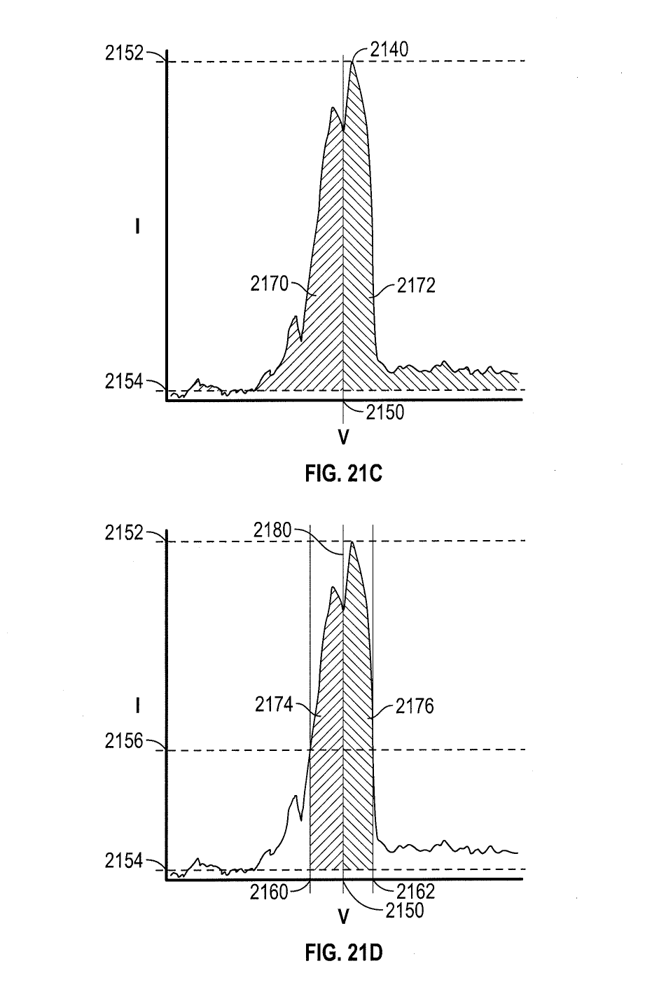

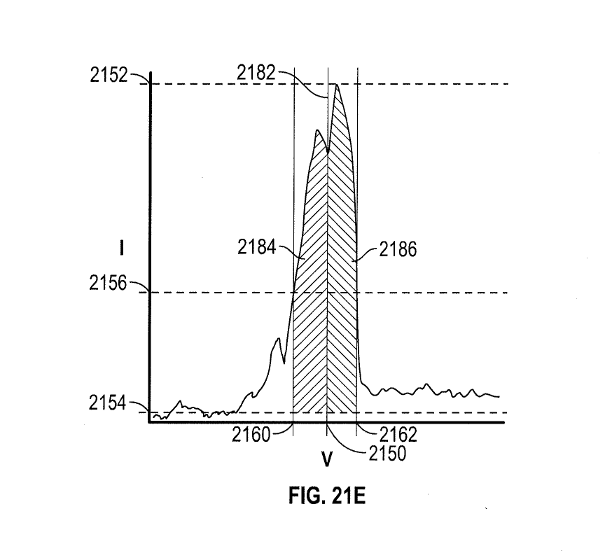

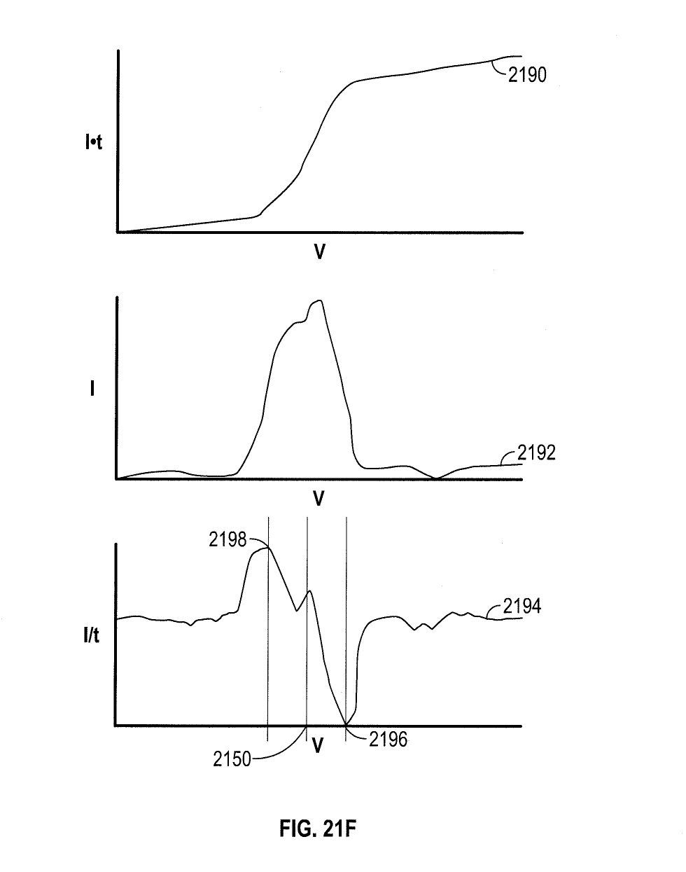

After applying the ramped voltage to the subset of the array, the method moves to at least one of blocks 2014, 2016, and 2018. At block 2014, the method evaluates data representing a pulse width of all or a portion of an induced current pulse. For example, the method may evaluate data according to some operations in the method of FIG. 21B. At block 2016, the method evaluates data representing an unweighted area of all of a portion of an induced current pulse. For example, the method may evaluate data according to some operations in the method of FIG. 21D. At block 2018, the method evaluates data representing a weighted area of all of a portion of an induced current pulse. Each of the blocks 2014, 2016, and 2018 may not be mutually exclusive. For example, the method may evaluate data according to some operations in the method of FIG. 21E and use data representing the unweighted area of all of a portion of an induced current pulse and data representing the weighted area of all of a portion of an induced current pulse.

After performing at least one of blocks 2014, 2016, and 2018, the method moves to block 2020. At block 2020, the method determines a drive response characteristic. The drive response characteristic may be determined based at least in part on one or more characteristics evaluated during at least one of the blocks 2014, 2016, and 2018.

FIGS. 21A-21F illustrate different methods of analyzing the current pulses detected during application of the ramp voltage to determine values for actuation and release of the display elements. The current pulse positions at the different portions of the ramp voltage input can be used to identify the values for VA50+, VR50+, VA50−, and VR50−. These values can be used as described above to calibrate the drive scheme voltages, for example, during use of the display array as described above.

Given a distribution of response characteristics of the interferometric modulators along a line being tested with the ramp voltage, it may be discerned that the modulators may not switch state simultaneously. When the modulators switch states at different voltages, the actuation or release produces a current pulse. The current pulse will have a certain width and may have structure including multiple local peaks within the total overall current pulse. A variety of methods may be used to analyze the data recorded by the analog to digital converter, derive a voltage value for actuation or release of the modulators from a recorded current pulse, and/or determine a drive response characteristic. Each FIG. 21A through 21F shows a waveform that represents an induced current as a function of ramp voltage value.

FIGS. 21A through 21F illustrate several different methods of analyzing the current pulses detected during the voltage ramps to derive drive response characteristics, including values for VA50+, VR50+, VA50−, and VR50−. In a first method shown in FIG. 21A, the recorded digital data is analyzed to find the voltage 2150 corresponding to the highest measured current 2140. The highest measured current 2140 is represented as the maximum amplitude of the waveform 2152 representing a single current pulse. The voltage 2150 corresponding to the highest measured current is taken as the drive response characteristic, here, the positive or negative actuation or release voltage V50. This method has some drawbacks when the current pulse has both a local or relative peak 2130 and an overall maximum current peak 2140, as shown in FIG. 21A. If the same line is tested multiple times, the relative heights of such peaks may change, such that different peaks within the structure are tallest during different test runs. This can cause variations in the derived V50. Variations may decrease the repeatability of the results.

FIG. 21B shows a data analysis method that finds the approximate middle of the entire current pulse. The data analysis method of FIG. 21B may be less affected by variations in local maximum amplitudes. In the method of FIG. 21B, the maximum current peak 2140 is first found, and a number of data points are selected on either side of the maximum current peak 2140. These data points may span about one to three volts of ramp change on each side of the peak 2140, for example. This number may be varied depending on the sampling rate and ramp output slope. In some implementations, a moving average may be performed on the set of data representing the number of selected data points in order to smooth the curve. A baseline current value 2154 may then be selected as an average or moving value of the first point or the first several points of the data set. A current value 2156 corresponding to a threshold between the maximum current amplitude 2152 and the baseline current value 2154 is selected. In the implementation in FIG. 21B, the current value 2156 is the mean of the maximum current amplitude 2152 and the baseline current value 2154 plus the baseline current value 2154. In other implementations, the threshold current value 2156 is selected by another method and may be lower or higher than the mean. Two voltages 2160, 2162 are then found. The first voltage 2160 corresponds to the ramp output generated at the time the current pulse reaches the current value 2156 as the current rises to reach the current peak 2140. In the example implementation, the first voltage 2160 is the voltage on the left of the maximum current peak 2140 where the measured value is halfway between the baseline current value 2154 and the maximum current amplitude 2152. The second voltage 2162 corresponds to the ramp output generated at the time the current pulse reaches the current value 2156 as the current pulse decreases following the current peak 2140. In the example implementation, the second voltage 2162 is the voltage on the right of the maximum current peak 2140 where the measured value is halfway between the baseline current value 2154 and the maximum current amplitude 2152. The first voltage 2160 and second voltage 2162 represent a width of the current pulse. The mean or average of the first threshold voltage 2160 and the second threshold voltage 2162 may then be used as the actuation or release voltage V50 2150 for the current pulse represented by the waveform evaluated.

This method described above in FIG. 21B uses a data representing a width to define the drive response characteristic, e.g., the actuation or release voltage V50 2150, rather than solely amplitude values. In other implementations, this method can be modified by selecting as V50 a value that is some amount higher or lower than the mean or average between the two voltages. For example, instead of the midpoint as described above, V50 can be selected to be the first voltage plus 60% of the voltage difference between the first threshold voltage and the second voltage, e.g., 60% of the way from the first voltage to the second voltage.

FIG. 21C shows a data analysis method that uses data representing an area to define a drive response characteristic, e.g., the actuation or release voltage V50 2150. In the method of FIG. 21C, the maximum current peak 2140 may be found, and a number of data points may be selected on either side of the maximum current peak 2140. This number may be varied depending on the sampling rate and ramp output slope. In some implementations, a moving average may be performed on the set of data representing the number of selected data points in order to smooth the curve. A baseline current value 2154 may then be selected. Data representing an area under the curve or the smoothed curve may be generated over the set of data representing the number of selected data points. In an example implementation, the value of the current minus the baseline current value 2154 is found for each data point in the set. The sum of these values represents the area under the waveform in this region.

This sum may be divided into two sections 2170, 2172. One section represents first section 2170 of the area under the curve and another section represents second section 2172 of the area under the curve. In some implementations, the actuation or release voltage V50 2150 may then be defined as the voltage at which 50% of the area under the curve is to the left of V50 2150 and 50% of the area is to the right. The voltage value 2150 may be found by performing the above sum one term at a time, starting from the first, lowest ramp voltage data point and moving up in ramp voltage data points until the sum equals or exceeds 50% of the total found above. The ramp voltage data point at which this occurs is voltage value 2150. In this implementation, the area represented by section 2170 is approximately equal to the area represented by section 2172.

This method uses data representing an area to define the V50 2150, rather than solely amplitude values. In other implementations, this method can be modified by selecting as V50 2150 a value that is some amount higher or lower than the halfway point between the two areas under the curve. For example, instead of the halfway point as described above, V50 2150 can be selected to be the voltage at which 60% of the area under the curve is to the left of V50 2150 and 40% of the area is to the right.

FIG. 21D shows a data analysis method that modifies the area comparison method of FIG. 21C. As in the method of FIG. 21C, the maximum current peak 2140 may be found, and a number of data points may be selected on either side of the maximum current peak 2140. This number may be varied depending on the sampling rate and ramp output slope. In some implementations, a moving average may be performed on the set of data representing the number of selected data points in order to smooth the curve. In the method of FIG. 21D, at the point where a baseline current value 2154 may be selected, the baseline current value 2154 may then be used to determine a threshold current value 2156 corresponding to a point between the maximum current amplitude 2152 and the baseline current value 2154. In the implementation in FIG. 21D, the current value 2156 is a value equal to the baseline current value 2154 plus approximately 30% of the difference between the maximum current amplitude 2152 and the baseline current value 2154. In other implementations, the current value 1256 is selected by another method, and may be lower or higher than this 30% value. Two voltage values may be determined. The first voltage value 2160 corresponds to the value of the ramp output voltage at the time when the current was approximately equal to the current value 2156 while the current was increasing before the maximum current peak 2140 was reached. The second voltage value 2162 corresponds to the value of the ramp output voltage at the time when the current was approximately equal to the current value 2156 while the current was decreasing after the maximum current peak 2140 was reached.

As in the method of FIG. 21C, data representing an area under the curve or the smoothed curve may be found. In the method of FIG. 21D, however, the area under the curve may be found only for the selected data points in the central region of the current pulse corresponding to the ramp voltage values between first voltage value 2160 and second voltage value 2162. The same sum as described above with reference to FIG. 21C may be performed, but limited to the data points between the first voltage value 2160 and the second voltage value 2162.

This sum may be divided into two sections 2174 and 2176. One section represents first section 2174 of the area of this region and another section represents second section 2176 of the area of this region. In some implementations, the actuation or release voltage V50 2150 may then be defined as the voltage at which 50% of the area under the curve is to the left of V50 2150 and 50% of the area is to the right. In this implementation, the area represented by section 2174 would be approximately equal to the area represented by section 2176.

This method uses data representing an area to define the V50 2150, rather than solely amplitude values. In other implementations, this method can be modified by selecting as V50 2150 a value that is some amount higher or lower than the halfway point between the two areas under the curve. For example, instead of the halfway point as described above, V50 2150 can be selected to be the voltage at which 60% of the area under the curve is to the left of V50 2150 and 40% of the area is to the right. In the method of FIG. 21D, the area is only considered where the response amplitude is greater than a selected percentage or fraction of the maximum current peak 2140, such as 30% of the maximum. This consideration of a limited range may reduce the contribution of noise that can appear near the outer boundaries of the current pulse.

FIG. 21E shows a data analysis method that modifies of the area comparison method of FIG. 21D. The method of FIG. 21E is substantially similar to that of FIG. 21D, except each term of the sum representing the area of FIG. 21D is weighted by the ramp output voltage. This sum is then divided by the unweighted sum computation of the method in FIG. 21D. At the point in the method of FIG. 21D after the selected data points corresponding to the voltage values between first voltage value 2160 and second voltage value 2162 are found, the value of the current minus the baseline current value 2154 weighted by the value of the ramp output voltage corresponding to the selected data point is summed across each data point in the set.

The actuation and release voltage V50 2150 may then be calculated by dividing the weighted area calculation by the area calculation described in the method of FIG. 21D. The V50 2150 may therefore correspond to a centroid voltage of the current pulse. This calculation may be represented by the formula below:

$$V50 = \frac{{\sum }_{i} {C}_{i} \cdot Vt}{{\sum }_{i} {C}_{i}}$$

FIG. 21F shows a data analysis method that finds the points of the pulse where the slope is maximum. In some implementations, the voltage at the maximum positive slope is found, and the voltage at the maximum negative slope is found. The V50 may be derived as the average of these two voltages.

In the method of FIG. 21F, a number of data points are selected on either side of the maximum current peak 2140. This number may be varied depending on the sampling rate and ramp output slope. An integral may be performed on the curve or waveform representing one or more current pulses or some portion of a current pulse. The integral may be performed over the range of the data set representing the selected number of data points. The integrated curve 2190 represents the integral of the current waveform. A moving average may then be performed on the curve 2190 in order to smooth the curve. A first derivative may be taken of the smoothed curve after the moving average is taken. The first derivative curve 2192 represents the first derivative of the integrated, smoothed current waveform. A second derivative may then be taken, such that the original waveform representing the sensed current has undergone an integral, a moving average, and two derivatives. The second derivative curve 2194 represents the second derivative of the integrated, smoothed current waveform.

The second derivative curve 2194 is then evaluated. In some implementations, the voltage at the maximum positive slope is found, and the voltage at the maximum negative slope is found. For example, a maximum amplitude point 2198 may be found and a minimum amplitude point 2196 may be found. A first voltage corresponding to the maximum amplitude point 2198 may be determined. A second voltage corresponding to the minimum amplitude point 2196 may be determined. A calculation may then be performed to determine the actuation or release voltage V50. For example, the V50 2150 may be determined by taking the voltage values corresponding to the average of the first voltage and the second voltage.

The methods of FIGS. 21B-21F may be more repeatable than other methods, including the method of FIG. 21A. The following table compares the repeatability for the various methods across an example test modulator array:

| | |
|---|---|
| Method | Repeatability |

| Methods | Description | VA50 (V) | VR50 (V) |
|---|---|---|---|
| 21A | Max VPeak | 0.47 | 1.30 |
| 21B | FWHM | 0.17 | 0.64 |
| 21C | Median | 0.35 | 1.06 |
| 21D | Median with Limits | 0.19 | 0.67 |
| 21E | Centroid with Limits | 0.18 | 0.38 |
| 21F | Integral | 0.77 | 1.42 |

The table includes rows corresponding to the method described for each FIG. 21A-21F. For each method, data corresponding to the repeatability for actuation voltage VA50 and release voltage VR50 was calculated. The repeatability data represents variations across three test runs for the 99.5% quantile. In the repeatability columns, lower numbers correspond to lower variations in the V50 derived using the data from the test modulator arrays. Generally, methods using data representing widths or weighted or unweighted areas produce more repeatable results for testing under the same conditions than the simple peak location measurement.

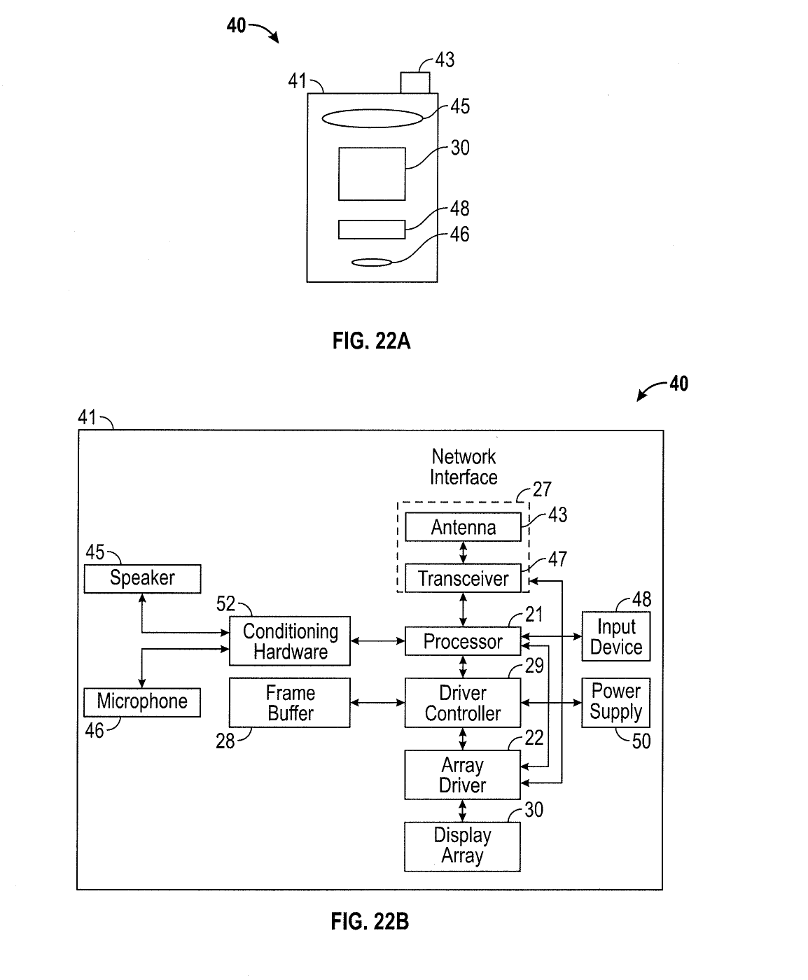

FIGS. 22A and 22B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 22B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 22B, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of calibrating an array of electromechanical elements, the method comprising:
applying a ramp voltage to a subset of the array and detecting an induced waveform including one or more current pulses;
evaluating one or more characteristics of the induced waveform in a region of the waveform containing at least a portion of a current pulse;
wherein the evaluating is based at least in part on data representing at least one of a width of all or the portion of the current pulse in the region and a weighted or unweighted area of all or the portion of the current pulse in the region; and
determining a drive response characteristic based at least in part on the evaluated characteristics.

2. The method of claim 1, further comprising determining an updated drive scheme voltage for the array based at least in part on the determined drive response characteristic; and driving the array of electromechanical elements using the updated drive scheme voltage.

3. The method of claim 1, wherein the evaluating one or more characteristics of the induced waveform in the region of the waveform containing at least a portion of the current pulse includes:
determining a value representing a peak current of the current pulse;
determining a first voltage substantially equal to the ramp voltage at which the current pulse reaches a first threshold lower than the peak current as the current is increasing; and
determining a second voltage substantially equal to the ramp voltage at which the current pulse reaches a second threshold lower than the peak current as the current is decreasing;
wherein the drive response characteristic is determined at least in part based on data representing a mean of the first voltage and the second voltage.

4. The method of claim 1, wherein the evaluating one or more characteristics of the induced waveform in the region of the waveform containing at least a portion of the current pulse includes:
calculating a value representing an area under a region of the induced waveform over a ramp voltage range containing at least a portion of the current pulse; and
wherein the evaluating is based at least in part on data representing a determined ramp voltage at which approximately half of the area under the region of the induced waveform over the ramp voltage range is below the determined ramp voltage and approximately half of the area under the region of the induced waveform over the ramp voltage range is above the determined ramp voltage.

5. The method of claim 4, wherein the region of the induced waveform over the ramp voltage range contains essentially all of the current pulse.

6. The method of claim 4, wherein the region of the induced waveform over the ramp voltage range contains only a central portion of the current pulse.

7. The method of claim 6, wherein the ramp voltage range corresponds to the region of the induced waveform where the current pulse exceeds a threshold value.

8. The method of claim 1, wherein the evaluating one or more characteristics of the induced waveform in the region of the waveform containing at least a portion of the current pulse includes:
calculating a value representing an area under a region of the induced waveform over a ramp voltage range containing at least a portion of the current pulse weighted by a corresponding ramp voltage value or a function thereof; and
wherein the evaluating is based at least in part on data representing a determined ramp voltage at which approximately half of the area under the region of the induced waveform over the ramp voltage range weighted by the corresponding ramp voltage value or function thereof is below the determined ramp voltage and approximately half of the area under the region of the induced waveform over the ramp voltage range weighted by the corresponding ramp voltage value or the function thereof is above the determined ramp voltage.

9. The method of claim 1, wherein the evaluating one or more characteristics of the induced waveform in the region of the waveform containing at least a portion of the current pulse includes calculating one or more values representing ramp voltages corresponding to approximately maximum slope portions of the region of the induced waveform.

10. An apparatus for calibrating drive scheme voltages, the apparatus comprising:
an array of electromechanical elements;
a ramped voltage generator;
a current sensor;
driver circuitry configured to drive the array of electromechanical elements using an initial set of drive scheme voltages; and
processor circuitry configured to:
initiate application of a ramp voltage to a subset of the array to produce an induced waveform including one or more current pulses;
evaluate one or more characteristics of the induced waveform in a region of the waveform containing at least a portion of a current pulse;
wherein the evaluating is based at least in part on data representing at least one of a width of all or the portion of the current pulse in region and a weighted or unweighted area of all or the portion of the current pulse in the region; and
determine a drive response characteristic based at least in part on the evaluated characteristics.

11. The apparatus of claim 10, wherein the processor circuitry is further configured to determine an updated drive scheme voltage for the array based at least in part on the determined drive response characteristic; and drive the array of electromechanical elements using the updated drive scheme voltage.

12. The apparatus of claim 10, wherein the processor circuitry is configured to evaluate one or more characteristics of the induced waveform in the region of the waveform containing at least a portion of the current pulse at least in part by:
determining a value representing a peak current of the current pulse;
determining a first voltage substantially equal to the ramp voltage at which the current pulse reaches a first threshold lower than the peak current as the current is increasing; and
determining a second voltage substantially equal to the ramp voltage at which the current pulse reaches a second threshold lower than the peak current as the current is decreasing;
wherein the drive response characteristic is determined at least in part based on data representing a mean of the first voltage and the second voltage.

13. The apparatus of claim 10, wherein the processor circuitry is configured to evaluate one or more characteristics of the induced waveform in the region of the waveform containing at least the portion of a current pulse at least in part by:
calculating a value representing an area under a region of the induced waveform over a ramp voltage range containing at least a portion of the current pulse; and
wherein the evaluating is based at least in part on data representing a determined ramp voltage at which approximately half of the area under the region of the induced waveform over the ramp voltage range is below the determined ramp voltage and approximately half of the area under the region of the induced waveform over the ramp voltage range is above the determined ramp voltage.

14. The apparatus of claim 13, wherein the region of the induced waveform over the ramp voltage range contains essentially all of the current pulse.

15. The apparatus of claim 13, wherein the region of the induced waveform over the ramp voltage range contains only a central portion of the current pulse.

16. The apparatus of claim 15, wherein the ramp voltage range corresponds to the region of the induced waveform wherein the current pulse exceeds a threshold value.

17. The apparatus of claim 10, wherein the processor circuitry is configured to evaluate characteristics of the induced waveform in the region of the waveform containing at least a portion of the current pulse at least in part by:
calculating a value representing an area under a region of the induced waveform over a ramp voltage range containing at least a portion of the current pulse weighted by a corresponding ramp voltage value or function thereof; and
wherein the evaluating is based at least in part on data representing a determined ramp voltage at which approximately half of the area under the region of the induced waveform over the ramp voltage range weighted by the corresponding ramp voltage value or a function thereof is below the determined ramp voltage and approximately half of the area under the region of the induced waveform over the ramp voltage range weighted by the corresponding ramp voltage value or the function thereof is above the determined ramp voltage.

18. The apparatus of claim 10, wherein the processor circuitry is configured to evaluate one or more characteristics of the induced waveform in the region of the waveform containing at least a portion of the current pulse at least in part by calculating one or more values representing ramp voltages corresponding to approximately maximum slope portions of the region of the induced waveform.

19. The apparatus of claim 10, wherein the processor circuitry is comprised of:
a processor that is configured to communicate with the array of electromechanical elements, the processor being configured to process image data; and
a memory device that is configured to communicate with the processor.

20. The apparatus of claim 19, wherein the driver circuitry is comprised of:
a driver circuit configured to send at least one signal to the array of electromechanical elements; and
a controller configured to send at least a portion of the image data to the driver circuit.

21. The apparatus of claim 19, further comprising:
an image source module configured to send the image data to the processor, wherein the image source module comprises at least one of a receiver, transceiver, and transmitter.

22. The apparatus of claim 19, further comprising:
an input device configured to receive input data and to communicate the input data to the processor.

23. An apparatus for calibrating drive scheme voltages, the apparatus comprising:
means for applying a ramped voltage to a subset of the array to produce an induced waveform including one or more current pulses;
means for evaluating one or more characteristics of the induced waveform in a region of the waveform containing at least a portion of a current pulse;
wherein the evaluating is based at least in part on data representing at least one of a width of all or the portion of the current pulse in a region and a weighted or unweighted area of all or the portion of the current pulse in the region; and
means for determining a drive response characteristic based at least in part on the evaluated characteristics.

24. The apparatus of claim 23, wherein the apparatus further comprises means for determining an updated drive scheme voltage for the array based at least in part on the determined drive response characteristic; and means for driving the array of elements using the updated drive scheme voltage.

25. The apparatus of claim 23, wherein the means for evaluating one or more characteristics of the induced waveform in the region of the waveform containing at least a portion of the current pulse includes:
means for determining a value representing a peak current of the current pulse;
means for determining a first voltage substantially equal to the ramp voltage at which the current pulse reaches a first threshold lower than the peak current as the current is increasing; and
means for determining a second voltage substantially equal to the ramp voltage at which the current pulse reaches a second threshold lower than the peak current as the current is decreasing;
wherein the drive response characteristic is determined at least in part based on data representing the mean of the first voltage and the second voltage.

26. The apparatus of claim 23, wherein the means for evaluating one or more characteristics of the induced waveform in the region of the waveform containing at least a portion of the current pulse includes:
means for calculating a value representing an area under the region of the induced waveform over a ramp voltage range containing at least a portion of the current pulse; and
wherein the evaluating is based at least in part on data representing a determined ramp voltage at which approximately half of the area under the region of the induced waveform over the ramp voltage range is below the determined ramp voltage and approximately half of the area under the region of the induced waveform over the ramp voltage range is above the determined ramp voltage.

27. The apparatus of claim 26, wherein the region of the induced waveform over the ramp voltage range contains essentially all of the current pulse.

28. The apparatus of claim 26, wherein the region of the induced waveform over the ramp voltage range contains only a central portion of the current pulse.

29. The apparatus of claim 28, wherein the ramp voltage range corresponds to the region of the induced waveform wherein the current pulse exceeds a threshold value.

30. The apparatus of claim 23, wherein the means for evaluating one or more characteristics of the induced waveform in the region of the waveform containing at least a portion of the current pulse includes:
means for calculating a value representing an area under the region of the induced waveform over a ramp voltage range containing at least a portion of the current pulse weighted by a corresponding ramp voltage value or function thereof; and
wherein the evaluating is based at least in part on data representing a determined ramp voltage at which approximately half of the area under the region of the induced waveform over the ramp voltage range weighted by the corresponding ramp voltage value or function thereof is below the determined ramp voltage and approximately half of the area under the region of the induced waveform over the ramp voltage range weighted by the corresponding ramp voltage value or function thereof is above the determined ramp voltage.

31. The apparatus of claim 23, wherein the means for evaluating one or more characteristics of the induced waveform in the region of the waveform containing at least a portion of the current pulse includes means for calculating one or more values representing ramp voltages corresponding to approximately maximum slope portions of the region of the induced waveform.

32. A computer readable medium having stored thereon instructions that, when executed by processing circuitry, calibrate an array of electromechanical elements by causing a calibration circuit to:
apply a ramp voltage to a subset of the array and detecting an induced waveform including one or more current pulses;
evaluate one or more characteristics of the induced waveform in a region of the waveform containing at least a portion of a current pulse;
wherein the evaluation is based at least in part on data representing at least one of a width of all or the portion of the current pulse in the region and a weighted or unweighted area of all or the portion of the current pulse in the region; and
determine a drive response characteristic based at least in part on the evaluated characteristics.

33. The computer readable medium of claim 32, wherein instructions that, when executed by processing circuitry, calibrate an array of electromechanical elements by causing a calibration circuit to further determine an updated drive scheme voltage for the array based at least in part on the determined drive response characteristic; and drive the array of elements using the updated drive scheme voltage.

34. The computer readable medium of claim 32, wherein the evaluation of one or more characteristics of the induced waveform in the region of the waveform containing at least a portion of the current pulse includes:
determining a value representing a peak current of the current pulse;
determining a first voltage substantially equal to the ramp voltage at which the current pulse reaches a first threshold lower than the peak current as the current is increasing; and
determining a second voltage substantially equal to the ramp voltage at which the current pulse reaches a second threshold lower than the peak current as the current is decreasing;
wherein the drive response characteristic is determined at least in part based on data representing the mean of the first voltage and the second voltage.

35. The computer readable medium of claim 32, wherein the evaluation of one or more characteristics of the induced waveform in the region of the waveform containing at least a portion of the current pulse includes:
calculating a value representing an area under the region of the induced waveform over a ramp voltage range containing at least the portion of the current pulse; and
wherein the evaluating is based at least in part on data representing a determined ramp voltage at which approximately half of the area under the region of the induced waveform over the ramp voltage range is below the determined ramp voltage and approximately half of the area under the region of the induced waveform over the ramp voltage range is above the determined ramp voltage.

36. The computer readable medium of claim 35, wherein the region of the induced waveform over the ramp voltage range contains essentially all of a current pulse.

37. The computer readable medium of claim 35, wherein the region of the induced waveform over the ramp voltage range contains only a central portion of a current pulse.

38. The computer readable medium of claim 37, wherein the ramp voltage range corresponds to the region of the induced waveform wherein the current pulse exceeds a threshold value.

39. The computer readable medium of claim 32, wherein the evaluation of one or more characteristics of the induced waveform in the region of the waveform containing at least a portion of the current pulse includes:
calculating a value representing an area under the region of the induced waveform over a ramp voltage range containing at least a portion of the current pulse weighted by a corresponding ramp voltage value or a function thereof; and
wherein the evaluating is based at least in part on data representing a determined ramp voltage at which approximately half of the area under the region of the induced waveform over the ramp voltage range weighted by the corresponding ramp voltage value or the function thereof is below the determined ramp voltage and approximately half of the area under the region of the induced waveform over the ramp voltage range weighted by the corresponding ramp voltage value or function thereof is above the determined ramp voltage.

40. The computer readable medium of claim 32, wherein the evaluation of one or more characteristics of the induced waveform in the region of the waveform containing at least a portion of the current pulse includes calculating one or more values representing ramp voltages corresponding to approximately maximum slope portions of the region of the induced waveform.
